(19) United States
(12) Patent Application Publication
(10) Pub. No.: US 2013/0214061 A1
(43) Pub. Date: Aug. 22, 2013

(54) SYSTEM FOR FAILSAFE CONTROLLED DISPENSING OF LIQUID MATERIAL

(71) Applicant: MARK MACLEAN-BLEVINS, WESTMINSTER, MD (US)

(72) Inventor: MARK MACLEAN-BLEVINS, WESTMINSTER, MD (US)

(21) Appl. No.: 13/846,427

(22) Filed: Mar. 18, 2013

Related U.S. Application Data
(63) Continuation of application No. 11/593,568, filed on Nov. 7, 2006.

(51) Int. Cl. B05B 7/12

(52) U.S. Cl. CPC B05B 7/12
USPC 239/310

(57) ABSTRACT

A system and method are provided for failsafe storage and dispensing of a liquid material from a container having a storage compartment. The system includes a container, a collapsible receptacle disposed within the container, and a disposing control unit coupled to the container. The container defines a storage compartment and an access opening in communication therewith, while the collapsible receptacle is disposed within the storage compartment for sealed storage of the liquid material therein. The dispensing control unit includes a control valve portion operable to selectively direct a flow path of at least a portion of a pressurized fluid stream that it receives. The dispensing control unit further includes a response valve portion coupled to the collapsible receptacle which is reconfigurable responsive to the pressurized fluid stream directed selectively thereto by the control valve portion to alternatively seal and open the collapsible receptacle. The response valve portion is resiliently biased to a configuration whereby release of the liquid material therethrough is prevented in the absence of suitable fluid pressure actuation.

### RELATED APPLICATIONS

This application is a Continuation of co-pending application Ser. No. 11/593,568 filed 7 Nov. 2006 which is based upon and claims the benefit of provisional Patent Application No. 60/734,264 filed 8 Nov. 2005.

### BACKGROUND OF THE INVENTION

1. Field of the Invention

The present invention is generally directed to the controlled dispensing of liquid materials. More specifically, it is directed to the failsafe control of such dispensing, reliably guarding against the inadvertent or unauthorized release of such liquid materials as potentially hazardous chemical compositions from containment, except when appropriate. The present invention is directed, moreover, to a system and method by which dispensing is effected in a manner responsive to a suitable pressurized stream of fluid.

Dispensing control devices of the type used with a pressurized stream of fluid, such as water provided through a conventional garden hose or other delivery means, are widely used in many applications. One example is a spray nozzle attachment for a garden hose which serves also as a dispensing assembly and capping means for a container of fertilizer, weed/pest control, or other highly concentrated lawn or garden treating chemical. Another example of the many applications is a sprayer attachment which controls the sprayed dispensing of liquid material from an air pump-type container.

Such dispensing control devices are typically activated to dispense the given material properly only when a pressurized stream of water or other appropriate fluid is provided. In situations where the pressurized fluid stream is not present, dispensing of the liquid material would invariably be inappropriate and all too often quite hazardous. On store shelves, for instance, containers of various liquid chemicals are displayed within easy reach of even small children. Despite the chemical materials' toxicity and noxious properties, the containers are often displayed in ready-to-use form, capped by nothing more than the dispensing control devices already placed on them.

The dispensing control devices are usually equipped with closure mechanisms and seals; however, they are prone to accidental or mischievous opening when knocked over, carelessly handled by a curious customer, or otherwise tampered with. The closures and seals of the type heretofore known may be defeated in this manner, whereupon potentially hazardous release of the contained chemical liquid may occur. Such a chemical spill is hazardous to the child as well as to other persons and animals in the area, including those who must clean up such a toxic spill. The resultant risk of serious, even fatal, injury due to poisoning, chemical burn, toxic inhalation, and the like potentially occurring in that event is self-evident.

There exists, therefore, a need for an approach to dispensing a liquid material which cannot be readily defeated by tampering or other disturbance. There exists a need, moreover, for a system and method of controlled dispensing which safely guards against the inadvertent or unauthorized release of the given liquid material until and unless the conditions for its safe release and use are actually present.

2. Prior Art

Closure devices for liquid product containers are known in the art, as are devices for controlling the dispensing of liquid products from containment. The best prior art known to Applicant include: U.S. Pat. Nos. 3,863,843; 4,244,494; 5,996,700; 4,971,105; 4,527,740; 5,007,588; 4,811,900; 4,508,272; 4,901,923; 5,375,769; 6,471,141; 6,435,773; 5,388,767; 4,142,681; 6,012,650; 5,533,546; 5,881,955; 3,940,069; 3,929,150; 3,763,888; 3,561,680; 4,176,680; 4,883,086; 4,105,044; 4,142,545; 4,154,258; 4,197,872; 4,775,241; 5,799,688; 4,047,541; 5,039,016; 5,100,059; 5,213,265; 5,320,288; 5,372,310; 5,383,603; 6,283,385; 6,378,785; 6,578,776; 4,826,085; 5,303,853; 3,666,150; 5,213,129; 5,129,730; 2,770,501; 5,293,946; 5,085,039; 2,988,139; 4,971,105; 3,863,843; 372,503; and, RE29,405. Such devices fail to provide the unique combination of features and advantages for failsafe closure and controlled dispensing of liquid materials to the degree provided by the present invention.

Numerous concentrated liquid products are now manufactured and sold in a retail environment in ready-to-use packaged containers (including bottles). Many are capped with sprayer type dispensing mechanisms configured for attachment to the end of a hose. Such sprayer type mechanisms serve to dilute the concentrated liquid product as it is dispensed, by an appropriate mixture ratio with the pressurized stream of water emerging from the hose. They serve also to expel the diluted mixture for appropriate application. Examples of uses widely found for this type of storage and dispensing of liquid products include lawn or garden care and weed/pest control, automobile cleaning, structural siding material cleaning, and so on.

A notable problem plaguing mechanisms of this type derive from the fact that they function as the ultimate closure for the concentrated chemical liquid product's container. Most of the currently available sprayer devices provide for some degree of chemical containment in that they offer an “off” setting, whereby the container is sealed for shipping and storage. Some mechanisms provide additional safety measures—like hydrophobic venting means to allow “breathing” of the container contents and thereby prevent the generation or build up of noxious vapors while stored. Others incorporate protective measures such as child-proof locking structures.

Still, the mechanisms heretofore known in the art fail to provide adequate safeguards against mechanical defeat and manipulation inappropriately away from its “off” setting. Nor do they adequately ensure failsafe re-sealing of the container following initial use of its product.

Hence, there remains a need for a controlled dispensing approach whereby dispensing is ultimately enabled independent of any mechanical means externally accessible to user manipulation. There remains a need for such controlled dispensing approach which actuates automatically, to control dispensing in a certain condition-responsive manner.

### SUMMARY OF THE INVENTION

It is a primary object of the present invention to provide a system and method for controlled dispensing of a liquid material which cannot be readily defeated by tampering or other disturbance.

It is another object of the present invention to provide a system and method which permits the liquid material to be dispensed only at the time of actual intended use.

It is another object of the present invention to provide a system and method for controlled dispensing of the liquid material in a manner responsive to a suitably pressurized stream of fluid directed thereto.

It is yet another object of the present invention to provide a system and method for controlled dispensing of the liquid material wherein the liquid material is stored in sealed manner within a collapsible receptacle for the controlled release therefrom.

It is still another object of the present invention to provide a system and method for controlled dispensing of the liquid material wherein liquid material stored in a collapsible receptacle is released therefrom in controlled manner in either aspirated or non-aspirated manner.

It is another object of the present system to provide a system and method for controlled dispensing of the liquid material whereby a precise mixture ratio substantially independent of available line pressure may be maintained in certain embodiments, such that substantially precise mixture is preserved despite fluctuations in line pressure.

It is still another object of the present invention to provide a system and method for controlled dispensing of the liquid material wherein dispensing control measures in certain embodiments may be disposed on or substantially integrated with a disposable container portion.

These and other objects are attained by the present invention in a system for failsafe storage and dispensing of a liquid material including a collapsible receptacle disposed within a storage compartment, and a dispensing control unit operably coupled to the collapsible receptacle. The collapsible receptacle is disposed within the storage compartment for sealed storage of the liquid material therein. The dispensing control unit includes a response valve portion coupled to the collapsible receptacle which is reconfigurable responsive to at least a portion of a pressurized fluid stream directed selectively thereto. The response valve portion thus controls release of the liquid material from the collapsible receptacle, serving in a first state to seal the collapsible receptacle, and in a second state to open communication with the collapsible receptacle. The response valve portion is resiliently biased to its first state, whereby release of the liquid material therethrough is prevented in the absence of suitable fluid pressure actuation.

In accordance with one aspect of the present invention, various embodiments incorporate a method for controlling the failsafe storage and dispensing of a liquid material wherein a storage compartment is established, and a liquid material product is stored in releasably sealed manner within a collapsible receptacle disposed in the storage compartment. A response valve portion is coupled to the collapsible receptacle for controlling release of the liquid material therefrom. The response valve portion is reconfigurable between first and second states responsive to selective application of a pressurized fluid stream thereto. The response valve portion in its first state seals the collapsible receptacle, and in its second state remains in open communication with the collapsible receptacle. The response valve portion is biased to one of the first or second states.

### BRIEF DESCRIPTION OF THE DRAWINGS

FIG. 1 is a sectional view of one embodiment of a system formed in accordance with the present invention, in an off configuration;

FIG. 1A is a front perspective sectional view corresponding to the embodiment as illustrated in FIG. 1;

FIG. 2 is a sectional view of the embodiment shown in FIG. 1, in a bypass configuration;

FIG. 2A is a front perspective sectional view corresponding to the embodiments as illustrated in FIG. 2;

FIG. 3 is a sectional view of the embodiment show in FIG. 1, in an ON configuration;

FIG. 3A is a front perspective sectional view corresponding to the embodiments as illustrated in FIG. 3;

FIG. 4 is a front perspective view of the embodiment as illustrated in FIG. 1;

FIG. 5 is a front perspective sectional view corresponding to the embodiment as illustrated in FIG. 1, but with a front spray nozzle rotated to a different setting;

FIG. 6 is a rear perspective, top down sectional view of the embodiment as illustrated in FIG. 2;

FIG. 7 is an elevational view of an alternate embodiment of a system formed in accordance with the present invention, in an OFF configuration;

FIG. 8 is an elevational view of the embodiment shown as illustrated in FIG. 7, attached to a liquid material container;

FIG. 9 is a front perspective view of the embodiment as shown in FIG. 7;

FIG. 10 is a rear perspective view of the embodiment of FIG. 7, in an ON configuration;

FIG. 11 is an elevational sectional view of the embodiment as shown in FIG. 8 attached to a liquid material container;

FIG. 12A is an enlarged view, partially cut away of the embodiment as shown in FIG. 11;

FIG. 12B is an enlarged sectional view corresponding to the embodiment of FIG. 12A, but in an intermediate operational configuration;

FIG. 12C is an enlarged sectional view corresponding to the embodiment of FIG. 12A, but in an ON operational configuration;

FIG. 13A is a rear perspective sectional view of the embodiment as illustrated in FIG. 12A;

FIG. 13B is a rear perspective sectional view of the embodiment as illustrated in FIG. 12B;

FIG. 13C is a rear perspective sectional view of the embodiment as illustrated in FIG. 12C;

FIG. 14 is a rear perspective view of a front section portion of the embodiment as shown in FIG. 8;

FIG. 15 is a rear perspective sectional view of the embodiment as illustrated in FIG. 12C, sectioned through a non-centered sectioning line;

FIG. 16 is a schematic view, partially cut away, of certain portions of a system formed in accordance with an exemplary embodiment of the present invention wherein at least a response valve portion is disposed in container-integrated manner;

FIG. 17 is a schematic view, partially cut away, of certain portions of the exemplary embodiment illustrated in FIG. 16;

FIG. 18A is a schematic diagram illustrating alternative operational principles realizable in accordance with certain exemplary embodiments of the present invention;

FIG. 18B is a schematic diagram illustrating certain alternative structural configurations for a delivery head portion of a system formed in accordance with certain exemplary embodiments of the present invention;

FIG. 19 is a schematic view of certain portions of a system formed in accordance with an alternate exemplary embodiment of the present invention wherein a liquid material is stored in a sealed collapsible receptacle;

FIG. 20 is a schematic diagram illustrating operational principles of certain portions of the exemplary embodiment illustrated in FIG. 19;

FIG. 21 is a schematic view of certain portions of a system formed in accordance with another alternate exemplary embodiment of the present invention wherein a liquid material is stored in a sealed collapsible receptacle;

FIG. 22 is a schematic view of certain portions of a system formed in accordance with yet another alternate exemplary embodiment of the present invention wherein a liquid material is stored in a sealed collapsible receptacle; and,

FIG. 23 is a schematic view of certain portions of a system formed in accordance with still another alternate exemplary embodiment of the present invention wherein a liquid material is stored in a sealed collapsible receptacle.

### DETAILED DESCRIPTION OF THE PREFERRED EMBODIMENTS

In overall operation, the failsafe dispensing system of the present invention serves the crucial function of controlling the safe release of potentially hazardous liquid materials from containment. It safeguards against the accidental or unauthorized release of the liquid material by operably coupling to the liquid material's source a valve assembly which cannot be fully actuated to permit the material's release without sufficient exposure to a suitably pressurized stream of fluid. In the absence of such pressurized fluid stream, the valve assembly remains un-actuated, preserving the closure of a container or other source from which the liquid material is to be dispensed. In accordance with the present invention, this closure cannot be readily defeated by manipulating or otherwise tampering with the valve assembly mechanically, by tipping the container, or by such other common means.

In many applications, a pressurized flow of water or other fluid is necessary in any event at the time of the liquid material's dispensing and use. In typical lawn and garden applications, for instance, the contained liquid material may be a highly concentrated fertilizer, insecticide, weed killer, or other such chemical formulation requiring a stream of water for dilution and/or transport. Release of the contained liquid material is then actuable only after the necessary preparations for the material's use, like attaching a garden hose or other conduit to deliver the pressurized fluid stream to the valve assembly, have actually been made. That is, dispensing of the liquid material is advantageously permitted only at the time of actual intended use.

Preferably, certain other measures are employed with the valve assembly for not only directing the pressurized fluid stream to and from the valve assembly effectively, but also for disabling the valve assembly from actuation, even when the pressurized fluid stream is present. This serves as an added safeguard which also enhances the degree of selectivity and control to the user. Such measures may be realized in the form of a simple locking mechanism upon the valve assembly, for example, or in various other forms as illustrated in following paragraphs.

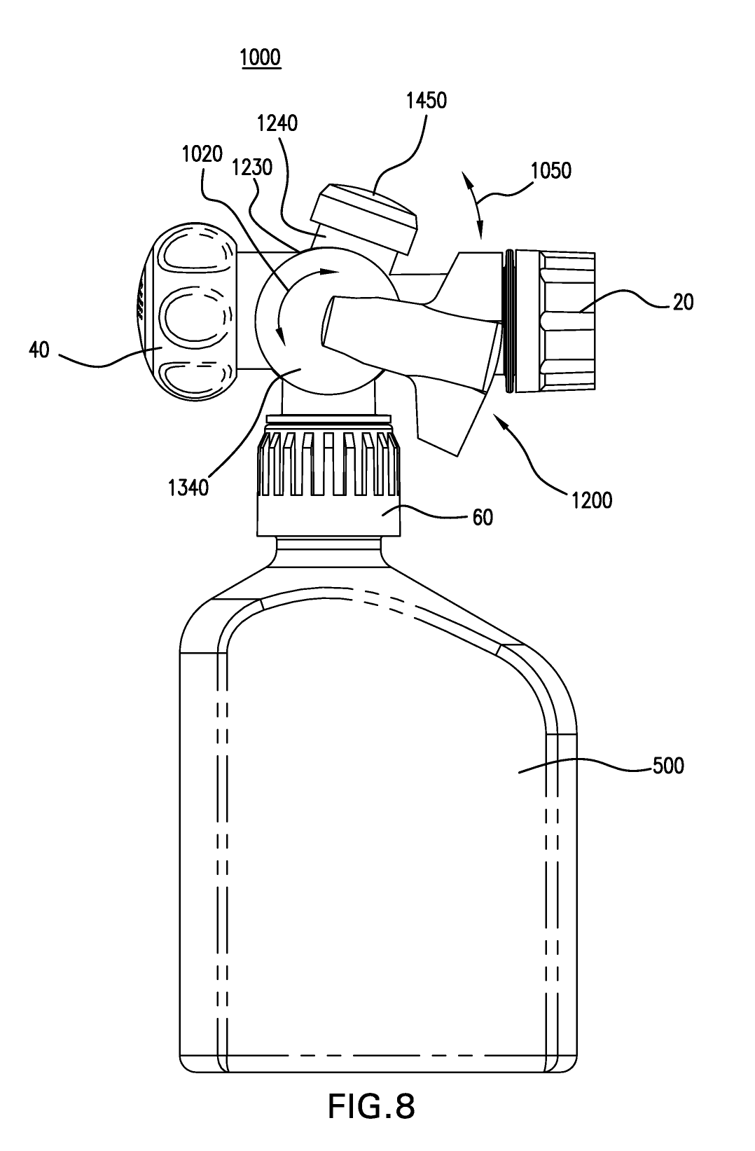

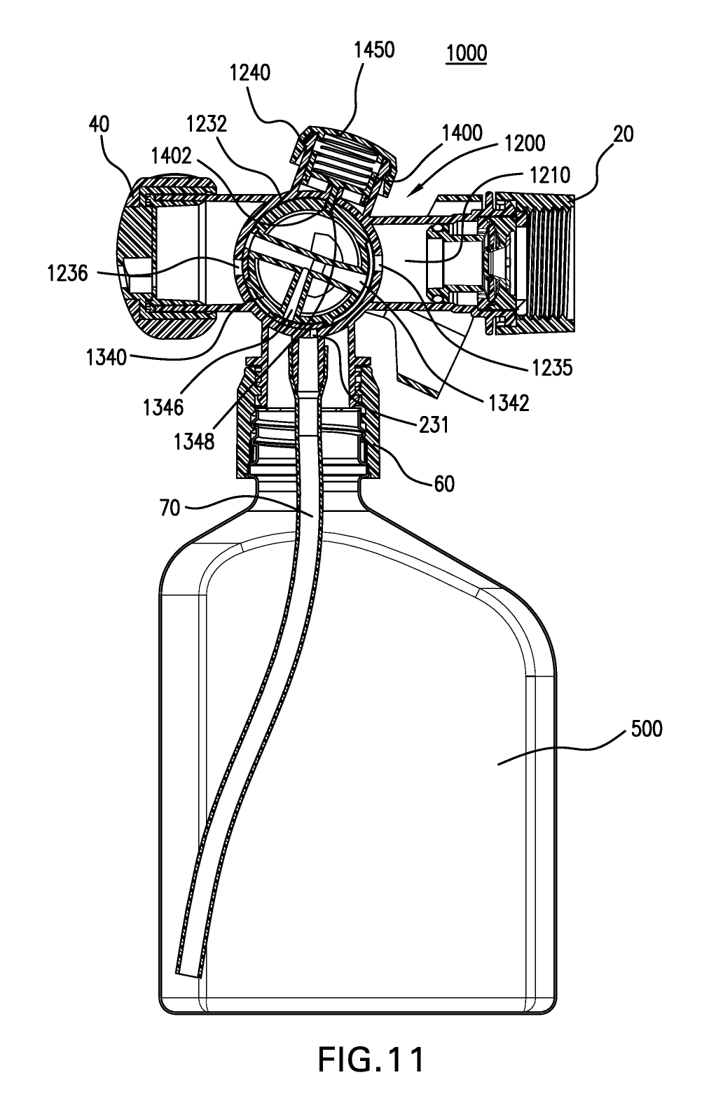

The source container for the liquid material (such as illustratively shown in FIGS. 8 and 11) may be of any suitable type known in the art. One common type is that of a portable dispensing jar which attaches to the system's housing to remain during use suspended therefrom, at the end of the hose. In certain other embodiments, the container may be formed to actually house the given valve assembly, the integrated valve assembly enjoying the added protection of the container against direct unwanted access.

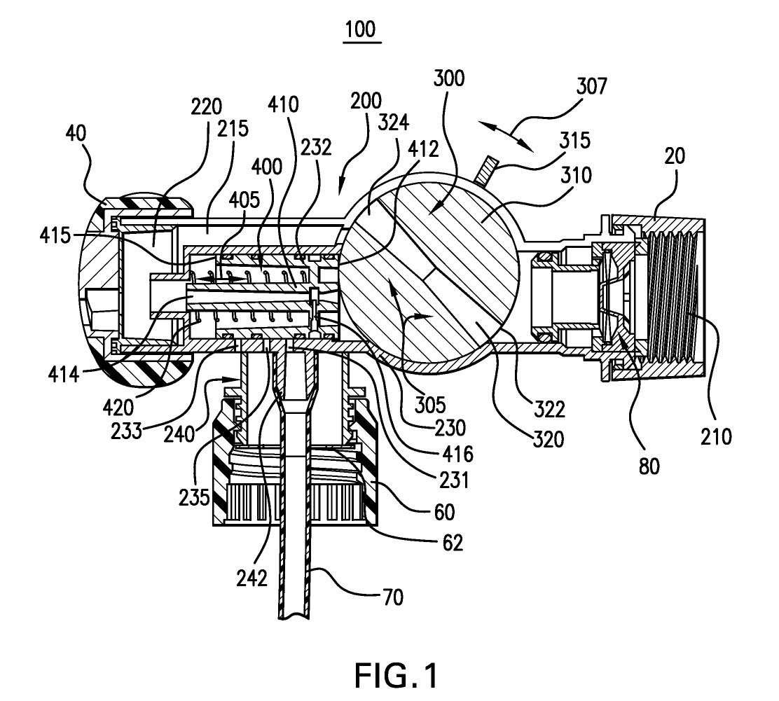

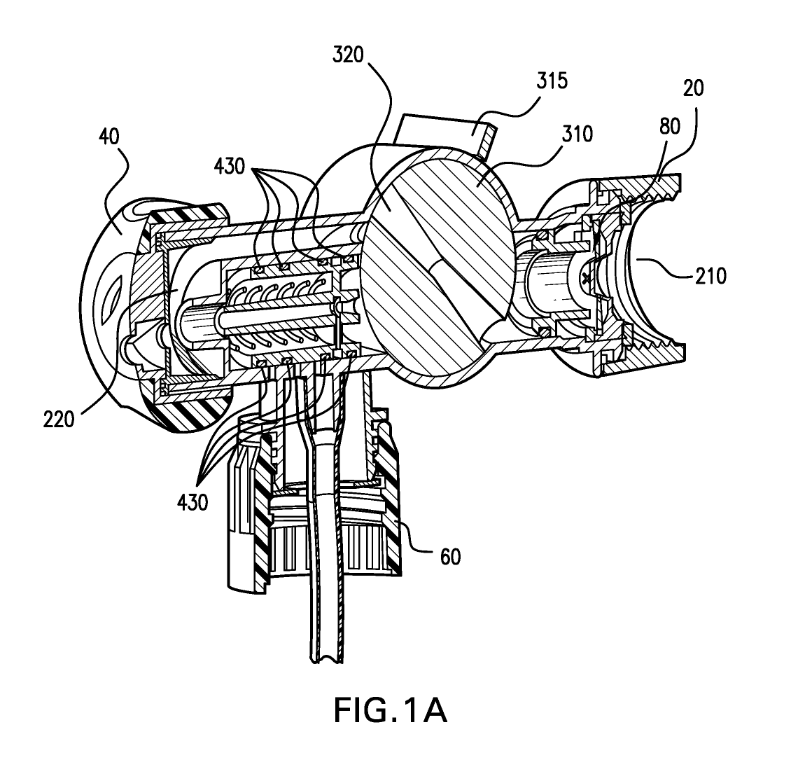

Referring now to FIGS. 1-4, there is shown one exemplary embodiment of a failsafe dispensing system 100 for safe controlled dispensing of a liquid material from its container or other storage source. In the disclosed embodiment, the system is of the type which invokes an aspiration-based technique (exploiting a Venturi effect, a flow-by effect, a Coanda effect, or the like) to draw the liquid material from its container for mixing and delivery to the targeted organism or material. This is but one example of numerous embodiments in which the failsafe controlled dispensing system 100 may be realized in accordance with the present invention.

In the illustrative embodiment shown, system 100 is formed as a sprayer attachment of a type typically fitted to the end of a garden hose, which expels with the fluid stream supplied by the hose a liquid material drawn from an attached holding container. As such, system 100 generally comprises a housing 200 preferably having a hose coupling 20 and back-flow prevention device 80 connected at its inlet 210, and a spray nozzle 40 connected at its outlet 220. An intermediate portion 230 of the housing 200 is formed with a coupling structure 240 which surrounds and extends from an admission port 231. An adapter 60 is preferably provided at a neck portion of the coupling structure 240 to facilitate attachment of, for example, a bottle-like container supplying the given liquid material. During use, the liquid material is drawn through the admission port 231 and into the housing's intermediate portion 230 for mixture with the hose-supplied fluid stream.

Devices such as the back-flow prevention device and spray nozzle 40 are shown in the FIGS. for illustrative purposes only, as they are not important to the present invention. The structure and function of such devices are well known to those skilled in the art, are not further described herein. Moreover, in the interest of brevity and clarity, they are not necessarily shown in the FIGS. in precise configurational detail.

System 100 also includes a control valve mechanism 300 and a response valve mechanism 400, both disposed within the housing's intermediate portion 230. In the exemplary embodiment shown, the control valve 300 serves the general function of selectively directing a pressurized fluid stream received through the inlet 210 in accordance with one of numerous configurations. Preferably, the control valve 300 may be alternatively set at least to open, bypass, and closed configurations. Depending in part on the prevailing configuration of the control valve 300, and in part on the supply of a suitably pressurized flow of fluid (typically though not necessarily water in the embodiment shown) through the inlet 210, the response valve 400 is maintained in one of at least two operational configurations—namely, active and inactive configurations. The response valve 400 in either configuration conveys any fluid received from the control valve 300 on to the outlet 220 for expulsion, but only in the active configuration permits the liquid material to be admitted into the housing 200 for mixture and expulsion with that fluid.

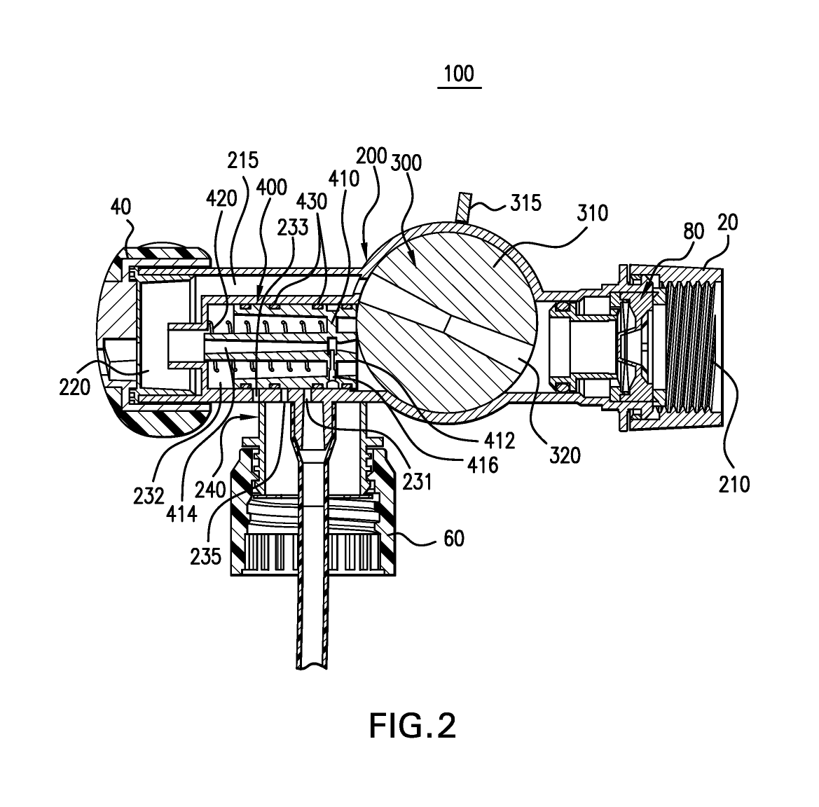

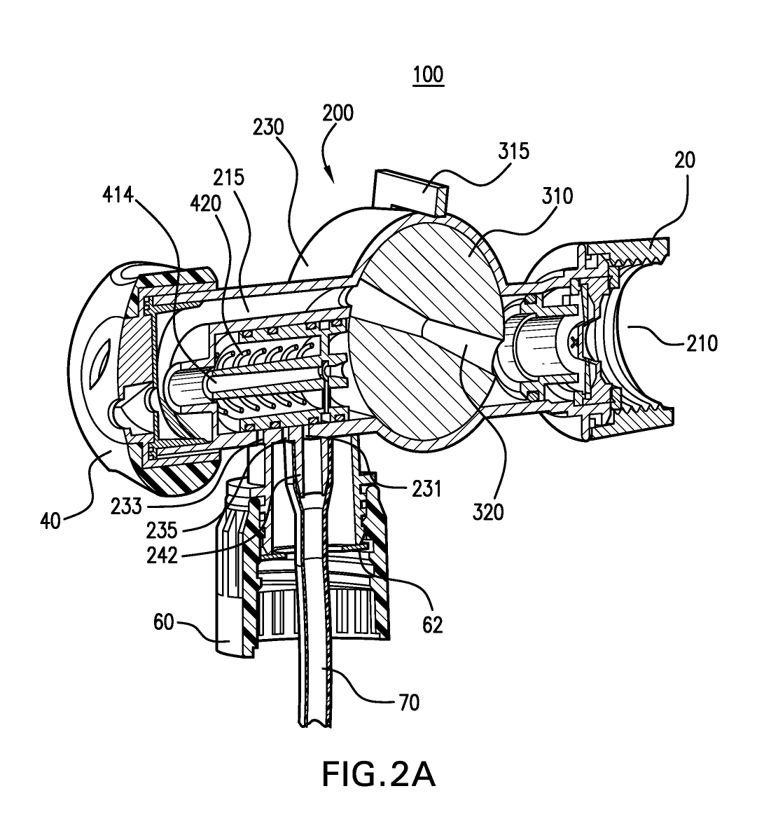

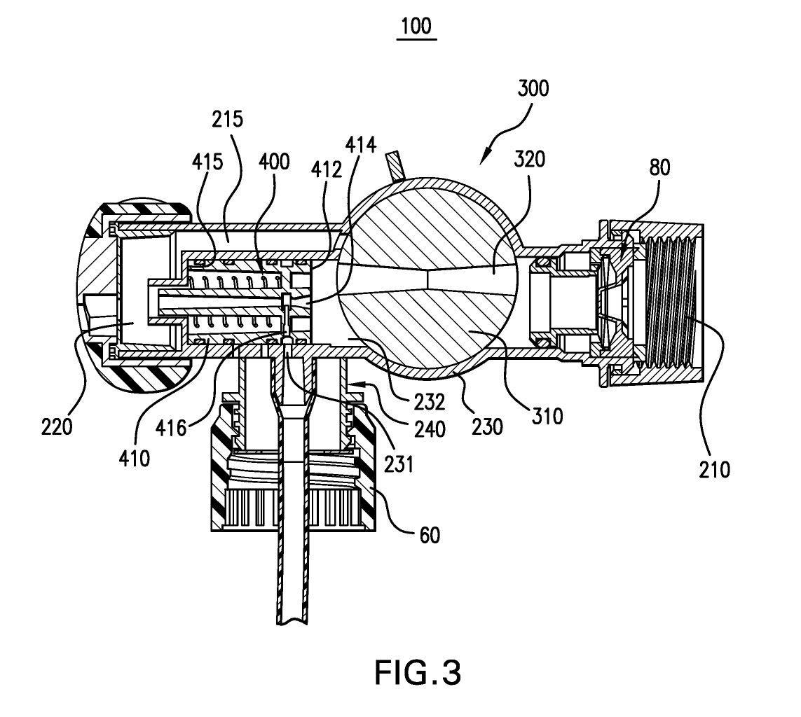

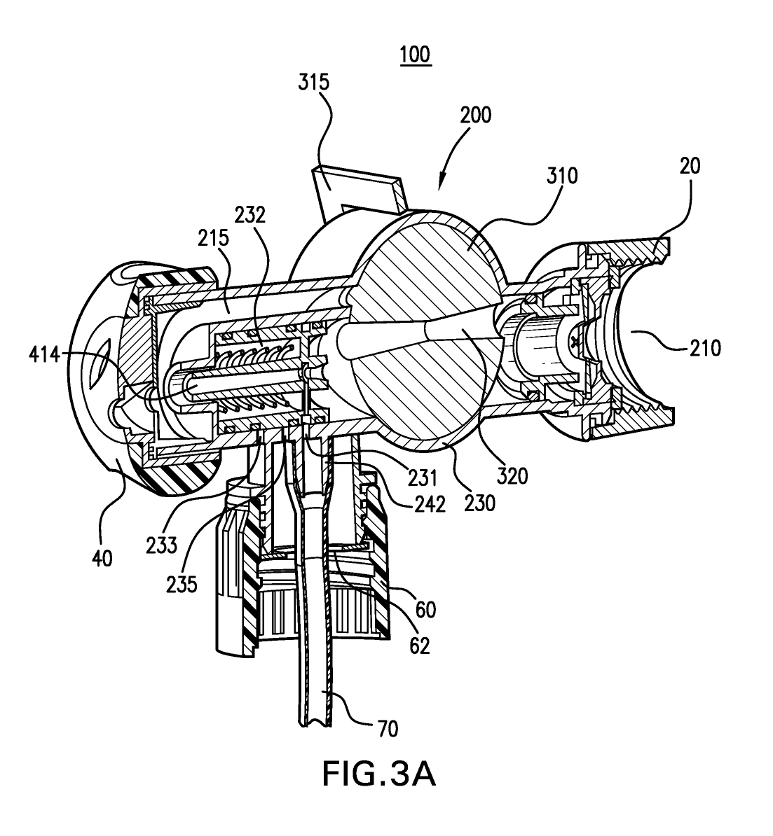

In the exemplary embodiment shown, the control valve 300 includes a rotary member 310 angularly displaceable along the direction indicated by arrows 305. It is so disposed within an accommodating space formed in the housing intermediate portion 230. A bore-like fluid conduit 320, preferably formed diametrically through the rotary member 310, may then be angularly positioned to one of several predetermined settings, preferably including: closed, bypass, and open settings. In FIG. 1 and its corresponding perspective sectional view of FIG. 1A, the fluid conduit 320 is set to the closed position, wherein its distal end 324 abuts (and is substantially blocked by) an inner surface of the housing's accommodating space, such that passage of the pressurized fluid through the conduit 320 is effectively blocked. In the corresponding FIGS. 2 and 2a, the fluid conduit 320 is set to the bypass (or rinse) position, in which it directs the flow of pressurized fluid entering its proximate end 322 to a bypass channel 215 that bypasses the response valve 400 and leads directly to the outlet 220. In corresponding FIGS. 3 and 3A, the fluid conduit 320 is set to the open position, where it substantially aligns with, and extends between, the inlet 210 and response valve 400. Preferably, a control member 315 is provided for readily accessible manual displacement along the direction indicated by arrows 307 to correspondingly position the rotary member 310 within the housing 200.

The location of the bypass position relative to the open and closed positions is preferably at an intermediate point between them, as in the embodiment illustrated. This allows a limited amount of pressurized fluid to flow from the fluid conduit 320 through the bypass channel 215, to the outlet 220, as the control valve's rotary member 310 passes while turning from the on position back to its closed position. One advantage is the flushing effect this has on any residual mixed product which may otherwise remain at the outlet upon shut-off. In addition, the back pressure resulting at the outlet end of the piston member 410 provides a measure of force to ‘push’ the piston member 410 back away from the outlet 220, aiding the piston member's quick and complete spring biased return to its inactive position.

The response valve 400 in the exemplary embodiment shown includes a displaceable assembly that may be displaced relative to the housing 200 between active and inactive positions. This is realized, for example, in the form of a piston member 410 disposed in axially displaceable manner, as indicated by directional arrows 405, within a receiving compartment 232 defined by the housing 200. The piston member 410 is preferably biased by a resilient member to one of its active and inactive positions. In the illustrated embodiment, the default position is the inactive position. That is, the piston member 410 is biased—or spring loaded—by a coil spring element 420 to its inactive position, away from the outlet 220 (and towards the control valve 300).

The piston member 410 is formed with an interface end 412 from which a mixing chamber 414 axially extends forward in bore-like manner, towards the outlet 220. A passage preferably configured as a transverse venturi aperture 416 leads from the mixing chamber 414 through to an outer surface of the piston member 410. In the response valve's inactive position (as shown in FIGS. 1, 1A and 2, 2A), this venturi aperture 416 is obstructed by an abutting inner surface of the immediately surrounding housing portion, while in the response valve's active position, it aligns with the housing's admission port 231 to open a path of access between the liquid material source and the mixing chamber 414.

The resilient member biasing the piston member 410 may be of any suitable type known in the art, such as the coil spring element 420 shown. It preferably applies a sufficient biasing force upon the piston member 410 to hold the default position until an opposing force sufficient to overcome the biasing force is applied thereto by an incoming flow of pressurized fluid emerging from the control valve's fluid conduit 320. Preferably, the biasing force applied by the resilient member is such that it may be amply overcome by the typical fluid flow pressures to be encountered in the intended application, yet is firm enough to resist stray forces which may be applied quite unintentionally and unexpectedly applied to the piston member 410 by various sources of potential disturbance, such as shock due to dropage, seepage of fluid through the control valve 300, and the like. In that regard, system 100 is preferably of an overall construction which guards suitably against open external access to the piston member 410, lest manual depression, obstruction, or other direct disturbance occur.

When the control valve 300 is set to its open configuration, and when a sufficiently pressurized flow of fluid passes concurrently through the fluid conduit 320, the fluid emerging from the fluid conduit's distal end 324 flows against the piston member's interface end 412. Not only does this impart a force upon that interface end 412, the pressurized accumulation of fluid resulting there builds up sufficient pressure to cause a responsive displacement of the piston member 410 against its spring loaded bias. The piston member 410 retracts until, either the opposing end 415 is stopped against the rear inner wall of the receiving compartment 232 or, alternatively, the force applied by the spring element 420 as it is compresses equalizes the pressure generated responsive to the pressurized fluid flow. In either case, the venturi aperture 416 is positioned such that it substantially aligns with the admission port 231 when the piston member 410 assumes its predetermined active position. As a portion of the pressurized fluid continues to flow through the piston member's mixing chamber 414, the given liquid material (whose source is coupled to the neck 240) is drawn through the admission port 231, through the venturi aperture 416, and into the fluid flow's path for subsequent mixture and expulsion therewith out through the outlet 220 and spray nozzle 440.

The aspiration required for such operation is preferably effected through at least first and second vent ports 233, 235 provided in the housing's intermediate portion 230. A plurality of seal members, preferably in the form of suitable O-rings are disposed about an outer surface of the piston member 410, preferably within accommodating annular recesses formed in that outer surface. When the piston member 410 assumes its inactive position, these seal members 430 bear against the surrounding walls of the receiving compartment to isolate the vent port 235 (disposed inside the neck 240) from the vent port 233 (disposed outside the neck 240) to prevent any seepage of air or liquid therebetween. When the piston member 410 assumes its active position, however, the seal members 430 are sufficiently displaced with the piston member 410, away from its intervening position between vent ports 235 and 233, unsealing to permit fluid communication between them. Atmospheric air is thereby permitted to enter the attached liquid container's interior to act on the liquid material contents.

In overall operation, then, the response valve 400 prevents the given liquid material from escaping through the admission port 231 when operational conditions are not present. That is, the outer side wall of its piston member 410 blocks the admission port 231 when in the inactive position shown in FIGS. 1, 1A and 2, 2A. A pair of seal members 430 serve in this position to seal against the seepage of any liquid material between the piston member 410 and the surrounding wall of the receiving compartment 232. Any such escaping liquid material is contained by the bounding seal members 430 such that the material would, if anything, fall back into the storage container via the admission port 231 itself, or via the immediately neighboring vent port 235.

In accordance with one aspect of the present invention, then, manipulating the control valve 300 to its open configuration is not alone sufficient to activate the response valve 400. A fluid flow of sufficient pressure to overcome the bias force maintained by response valve 400 must also be present for its activation.

The housing 200 is preferably formed of hard plastic or other suitable material known in the art of sufficient strength, rigidity, and durability to withstand the conditions typically encountered in the intended application. In applications posing particularly harsh conditions, considerations such as anti-corrosion, thermal expansion, and the like may be significant factors determining the choice of materials for various portions of system 100. The present invention is not limited to a particular choice of materials, as such choice will depend on the particular requirements of the intended application.

Turning now more closely to the structure for coupling a container or other source of the liquid material (highly concentrated lawn treatment chemical, for instance), a suction tubing 70 positioned with an upper end engaging a nipple 242 and a lower end extending to the bottom of the given container (not shown). If the container is of the type having a threaded opening, it may be threadedly engaged with the adapter 60 for suspension therefrom. Within the adapter 60, a seal 62 such as a flattened O-ring or washer is preferably provided at the sprayer-container interface to prevent air and liquid material leakage. Other attachments such as snap-on, lock-in-key, dovetail, or other such coupling mechanisms known in the art may be alternatively employed.

Various alternative embodiments may be realized in accordance with the present invention. In certain alternative embodiments, for example, the spray nozzle 40 may be replaced by another downstream flow control valve device such as an extension wand or other fluid-conducting attachment coupled to the outlet 220. In certain other exemplary embodiments, an optional detent ball mechanism or other such retaining device may be incorporated in the control valve 300 to give tactile feedback when the valve 500 is optimally positioned for a particular function. Such a detent ball mechanism may be seated with a biased ball partially received within a recess formed in the control valve accommodating space within which the rotary member 310 is seated. One or more corresponding detent recesses may then be formed in the opposing surface of the rotary member 310.

With particular respect to operation when the control valve 300 is set to its open configuration, among the forces overcome by the pressure build up at the piston member interface end 412 are not only the biasing force exerted by a coil spring 420, but also inertial forces due to such things as the friction generated between the piston member and the surrounding inner surfaces of the receiving compartment 232. This friction is exacerbated by the O-rings 430, seated in the circumferential grooves/recesses formed on the piston member's exterior. In certain alternative embodiments, then, a biasing member is obviated by the inertial drag collectively generated by a suitable plurality of static seal members 430. The resultant ‘O-ring drag’ in such embodiments is sufficient to retain the piston member 410 in the inactive position in the absence of pressurized fluid flow thereto through an open control valve 300. The piston interface end 412 on which the pressurized fluid acts to create a displacement force preferably remains unexposed to points outside of the housing 200, so as to prevent unwanted mechanical manipulations, via a pencil or other foreign object.

In those alternate embodiments where a extension wand having a flexible hose for accurate spot location of the delivered stream is employed at the outlet 220, and the wand is itself equipped with an on/off control mechanism, the response valve 400 serves to protect the container's contents by closing fluid communication between the container and the piston valve compartment. More specifically, when the wand on/off valve is open and the response valve 400 is activated, admission of the concentrated chemical or other given liquid material into the pressurized flow is permitted. When the wand valve is turned off, the fluid pressure quickly equalizes on both sides of the biased piston valve, allowing the piston member's biased return to its inactive position—even if the control valve 300 were still in an open configuration at that instant.

The O-rings forming the seal members 430 in the embodiment shown are preferably formed of a suitable elastomeric material known in the art. They provide hermetic sealing of the interface between the piston member 410 and the immediately opposing sidewalls of the receiving compartment 232. As mentioned in preceding paragraphs, the O-rings serve to fluidically separate certain sections of the piston member 410. Preferably, enough seal members 430 are employed such that proximal and distal O-rings are disposed adjacent the opposed axial ends of the piston member 410 so to provide hermetically sealed protection for most of the piston member's length.

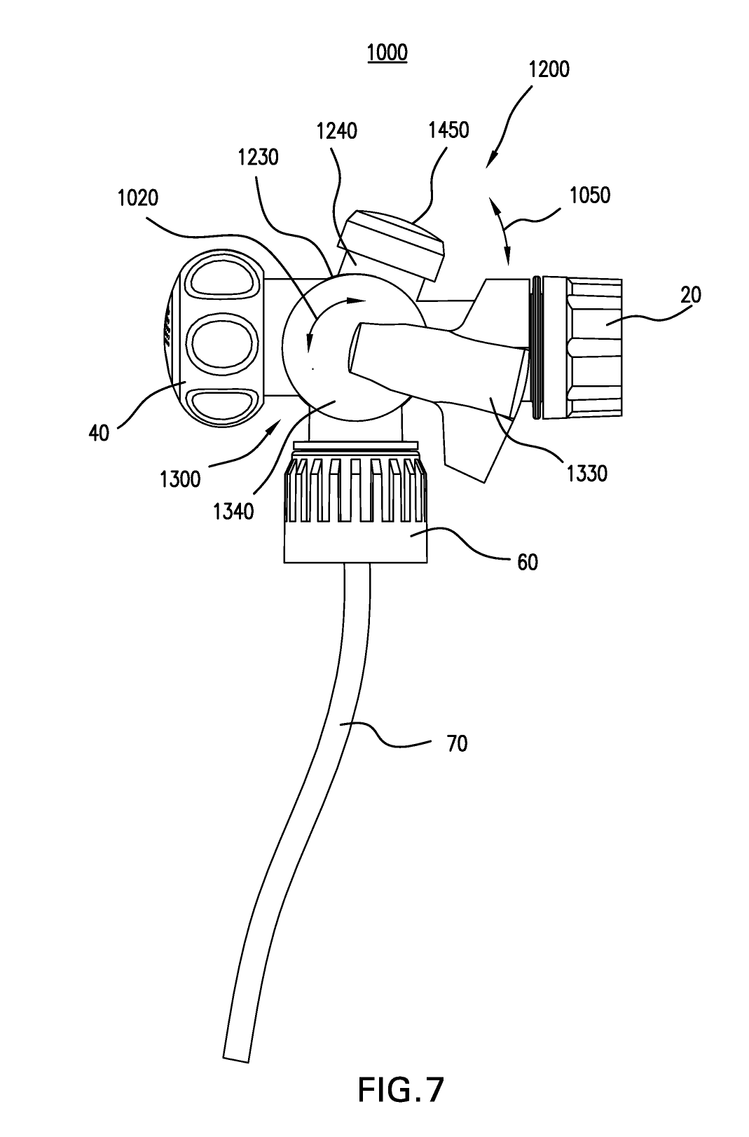

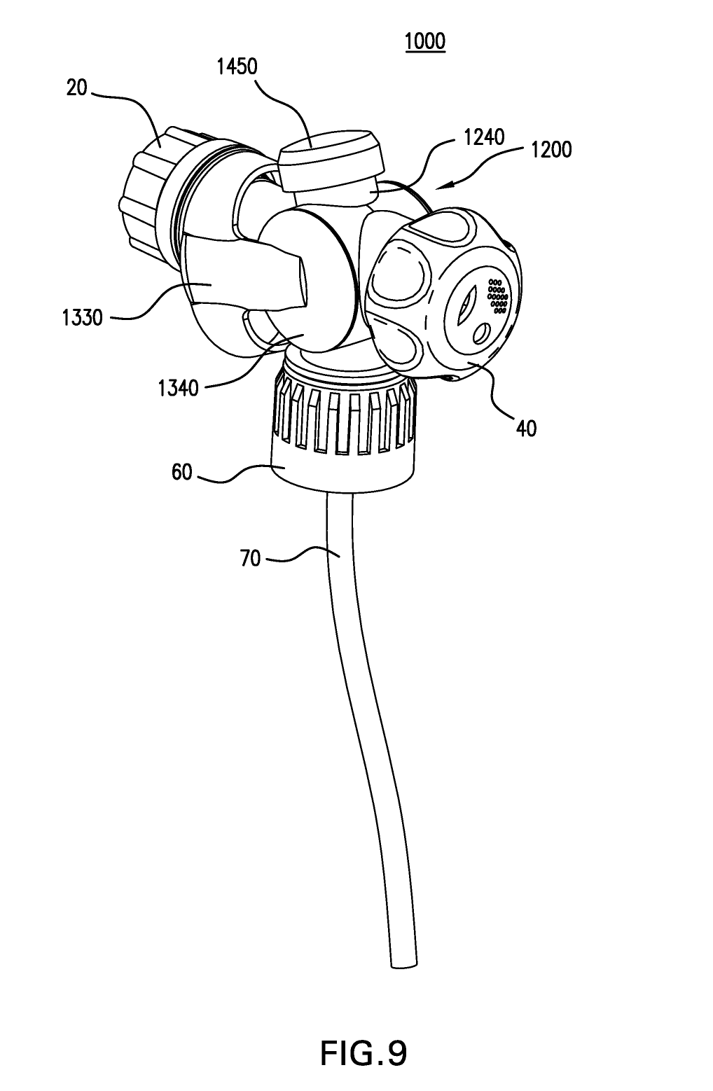

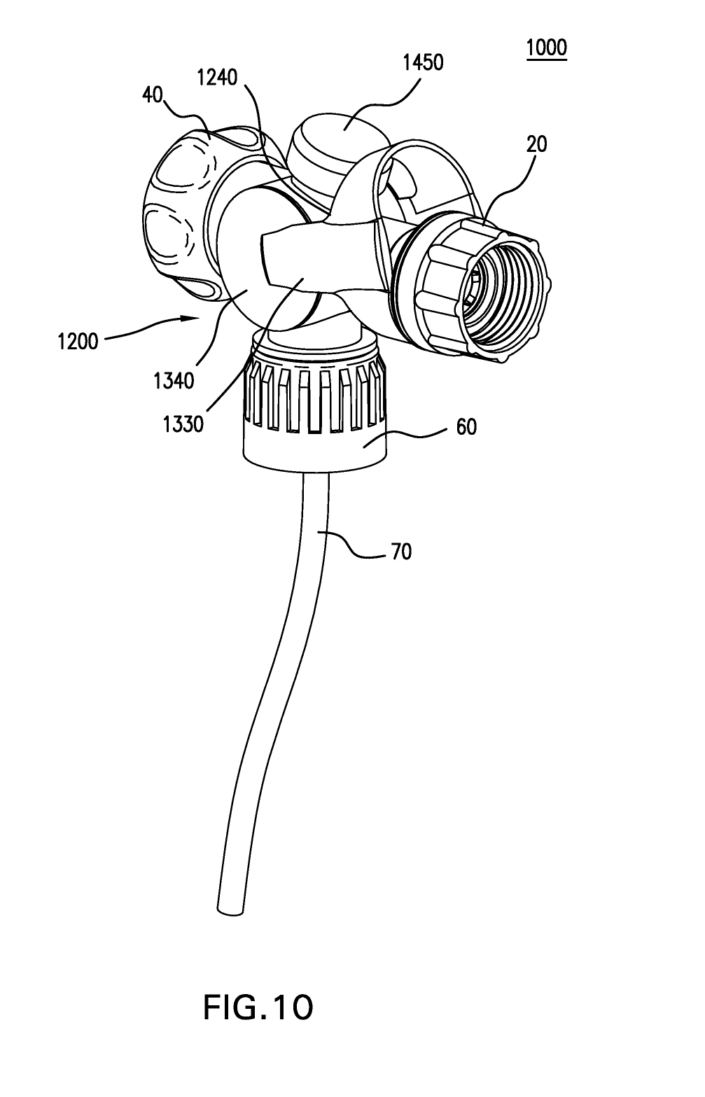

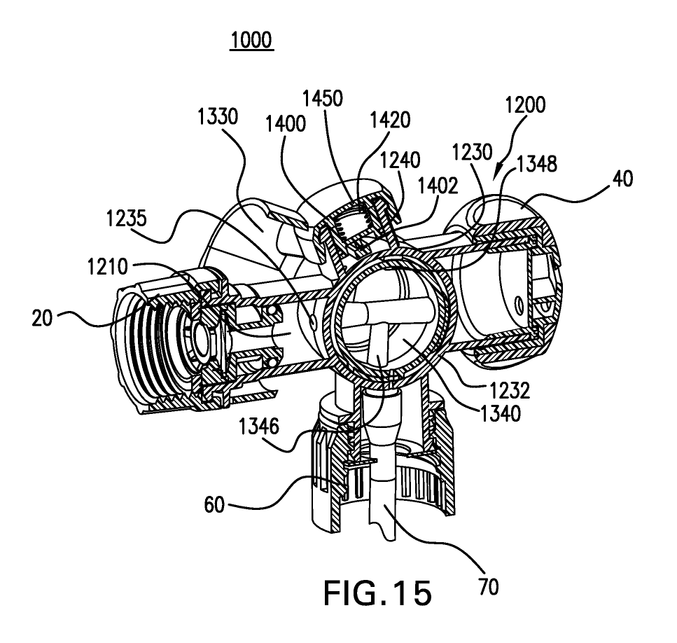

Referring now to FIGS. 7-15, there is illustrated another exemplary embodiment of the present invention. Like reference numbers are used in these FIGS. to denote the same or substantially the same elements as those shown in the preceding embodiment. System 1000 formed in accordance with this embodiment generally includes a housing 1200 having an intermediate portion 1230 to which a central valve assembly 1300 is coupled. As shown in FIG. 8, among others, the system 1000 is of the type which may be coupled for use to a top opening, or neck, of a bottle-like container 500 which holds the liquid material to be safely dispensed.

Briefly, the central valve 1300 in this embodiment effectively combines the functions generally served by the control valve 300 and response valve 400 in the preceding embodiment. It is formed internally with a suitable channeling structure which, as in the preceding embodiment, aligns with an admission port 231 to enable the given liquid material to be drawn from its source and appropriately dispensed. Preferably, the channeling structure includes a bore-like fluid conduit 1342 extending diametrically through the central valve assembly's main body portion 1340 and a venturi aperture 1346 branching from that fluid conduit 1342. Angular displacement of the main body portion 1340 relative to the housing 1200 (as indicated by directional arrows 1020 and 1050) then controls the selective alignment of the venturi aperture 1346 with the admission port 231.

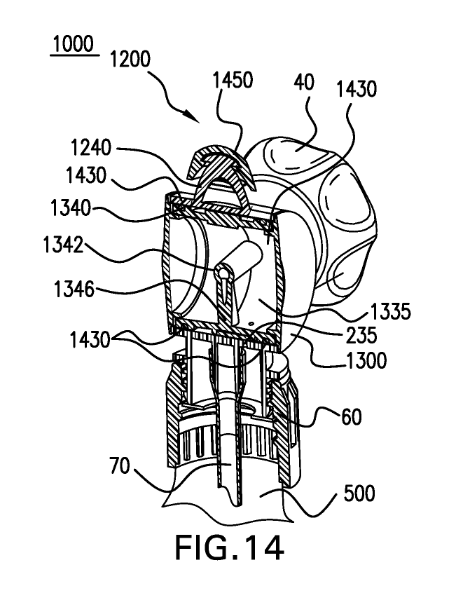

When aligned, the admission port 231 and fluid conduit 1342 are in open communication, whereby the liquid material may be drawn into the housing for mixed dispensing with that portion of the pressurized fluid stream passing through the fluid conduit 1342. At other angular positions of the main body portion 1340 relative to the housing 1200, the venturi aperture 1346 is turned out of alignment with the admission port 231, such that the admission port is closed off by a sealing wall surface 1344 of the main body portion 1340 and any suitable seal members 1430 (as illustrated in FIG. 14) provided therewith.

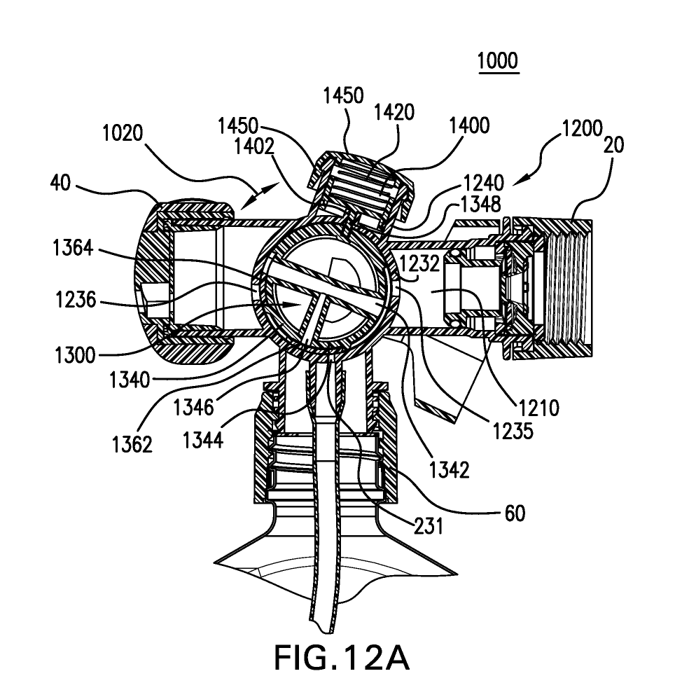

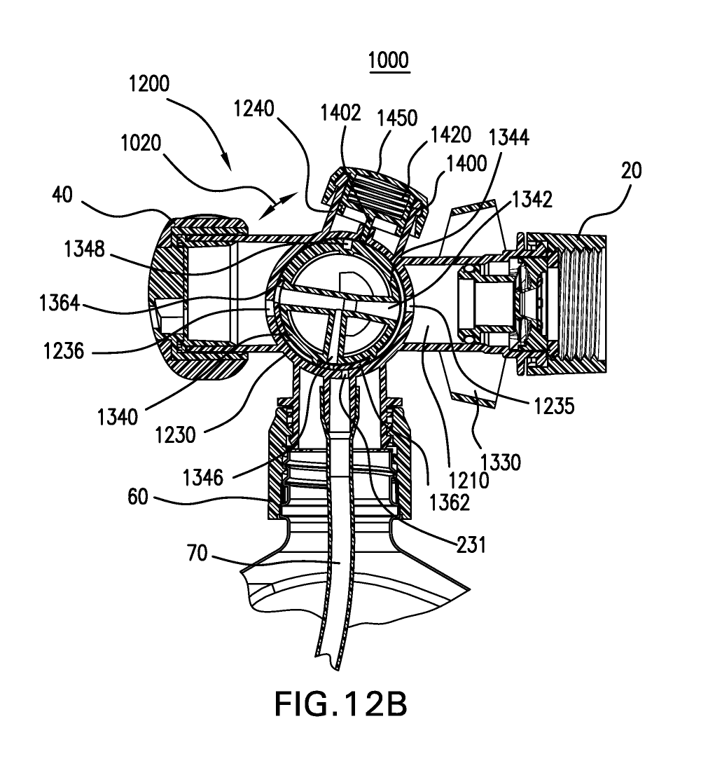

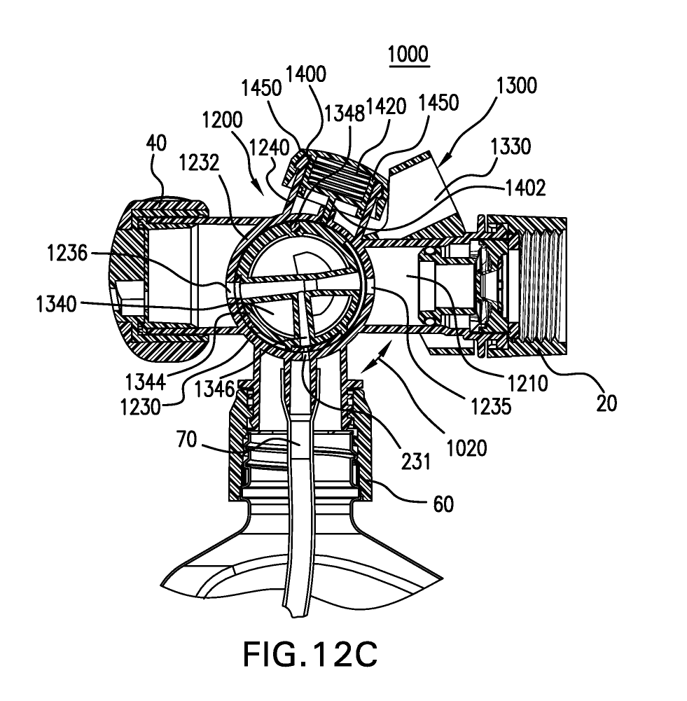

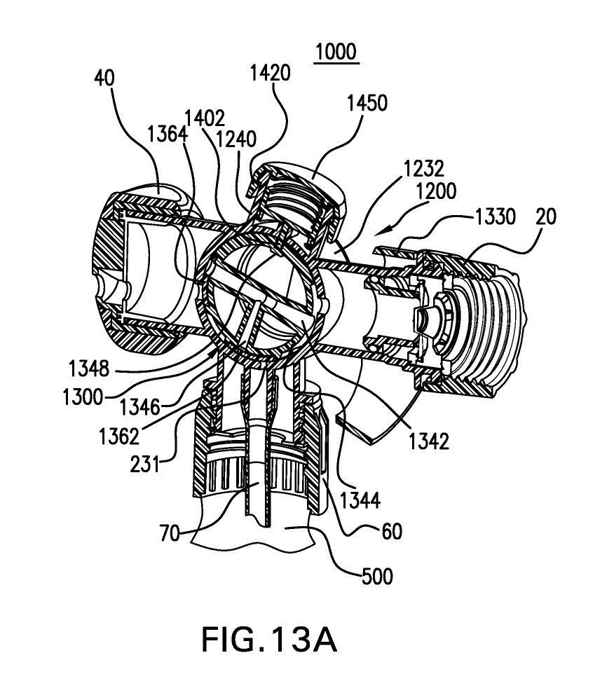

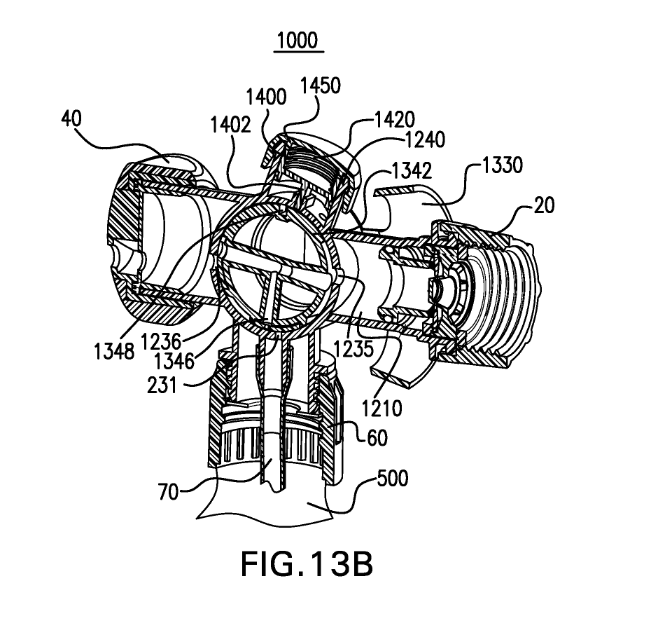

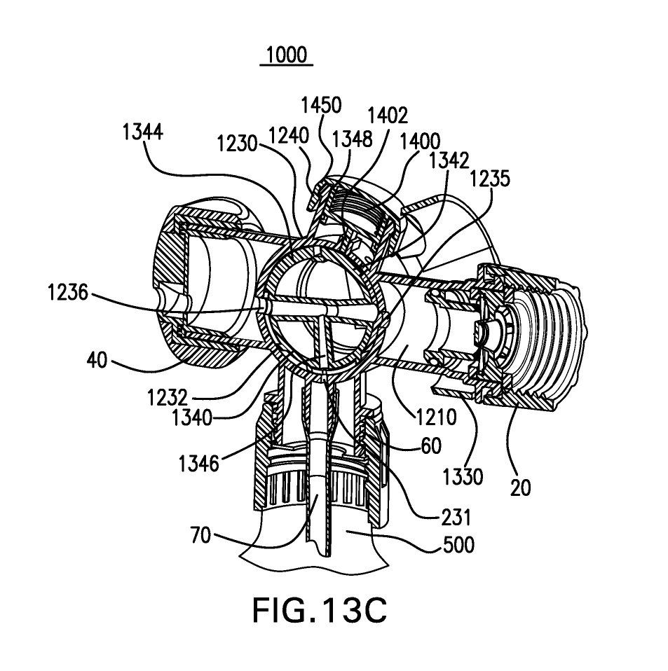

FIGS. 12A, 12B, and 12C (as well as FIGS. 13A-C) respectively illustrate in sequence the closed/inactive, intermediate, and open/active positions of the central valve assembly 1300 relative to the housing's intermediate portion 1230. In accordance with this particular embodiment, the central valve assembly 1300 is mechanically interlocked to the housing 1200, preferably in its closed or inactive angular position. This mechanical interlock, which disables the central valve assembly 1300 from activation, may be properly overcome only when a sufficiently pressurized stream of fluid is suitably introduced into the flow path defined by the housing 1200. In the absence of such pressurized fluid stream, the interlocking mechanism remains engaged, inaccessible as it is from outside the housing 1200 that it cannot be readily defeated by mechanical manipulation.

In this embodiment, the main body portion 1340 is seated within a generally cylindrical chamber 1232 defined transversely through the housing's intermediate portion 1230. The main body portion 1340 is correspondingly shaped and dimensioned such that it may turn within this transverse chamber 1232 unless otherwise obstructed. Such obstruction is interposed in the form of a retractable locking member 1400 positioned within a compartment 1240 situated outside the chamber 1232. The locking member 1400 includes a protruding boss 1402 that extends into the transverse chamber 1232 when the locking member is in its locking position, to engage a recess 1348 formed in the valve assembly's main body portion 1340. The central valve assembly 1300 is thereby interlocked to the housing 1200, preferably at its inactive position.

The locking member 1400 is retained within the auxiliary compartment 1240 preferably by a retaining cap 1450. A resilient member, such as a coil spring 1420 is captured between the locking member 1400 and retaining cap 1450, biasing the locking member 1400 towards the transverse chamber 1232. The protruding boss 1402 is thus urged to extend into the chamber 1232 unless pushed back by a pressure sufficient to overcome the spring's biasing force.

Within the housing 1200, fluid flow access into and out of the transverse chamber 1232 is provided through axially opposed access openings 1235, 1236. Except at the respective outlet ends of the central valve's venturi outlet port 1346 and fluid conduit 1342 (where suitable sealing measures 1362, 1364 are employed), sufficient (though minute) clearance is provided between the opposing surfaces of the relatively movable main body portion 1340 and transverse chamber 1232 to permit fluid communication therebetween. When a suitably pressurized stream of fluid is then directed into the flow path 1210 defined in the housing 1200, it passes through the access opening 1235 into the chamber 1232. The entering fluid quickly disperses through the clearance space between the valve's main body portion 1340 and inner walls of the chamber 1232 until the resulting build up of pressure therein urges the locking member 1400 away from the chamber 1232, causing the consequent retraction of the protruding boss 1402. Upon full withdrawal of this boss 1402 from recess 1348, the central valve 1300 is unlocked, or enabled, for angular displacement to its active configuration. A user at this point may effect the activating displacement necessary via a lever handle 1330 extending externally from the main body portion 1340.

While the valve assembly 1300 is in its active configuration, the locking boss 1402 remains retracted and out of the valve's way. When the pressurized fluid stream is interrupted, however, the opposing build up of pressure is lost, and the locking member 1400 is again freed to advance by force of the biasing spring and extend its protruding boss 1402 into the chamber 1232. This can only occur when the valve assembly 1300 is returned to its inactive configuration, and the recess 1348 comes to be aligned again with the protruding boss 1402 to receive its interlocking engagement.

Referring to the cross-wise sectional view shown in FIG. 14, certain features not visible in the lengthwise sectional views of the other FIGS. are visible here. In particular, a vent port 235 is provided to remain effectively sealed off from the other portions of the system 1000 by the central valve's main body portion 1340 and cooperating O-ring type seal members 1430, when the central valve assembly 1300 is in anything other than its active configuration. When the valve assembly 1300 is in its active configuration as shown, a corresponding vent opening 1335 formed through the sealing wall surface 1344 of the main body portion 1340 aligns with the vent port 235 to permit the required aspiration therethrough. Sufficient fluid communication occurs for adequate venting between the vent opening 1335 and the air outside the housing 1200, much as in the preceding embodiment, through unsealed joints and/or minute gaps at the interface of moving components found in the resulting structure, as well as through any supplemental apertures which may be suitably formed in the structure for that purpose.

Depending on the requirements of the intended use, it may be preferable in practice to use the hydraulic source pressure for direct control of the liquid material container's sealing valve as in the first embodiment, rather than for unlocking a valve controlled by other means, as in the present alternate embodiment. One practical drawback is that the interlocking mechanism could be damaged and/or defeated more readily by forcible means. Even so, such hydraulically activated interlock embodiment provides still a higher level of safety than heretofore afforded by comparable devices known in the art.

Numerous alternate embodiments of the present invention other than those illustrated in the FIGS. herein abound. In one such alternate embodiment, the valve assembly may be housed within the liquid material's container itself, to further guard against unwanted tampering. The container is provided with suitable inlet and outlet access points for receiving the required stream of pressurized fluid from a source and delivering the liquid material in appropriate amount for proper expulsion.

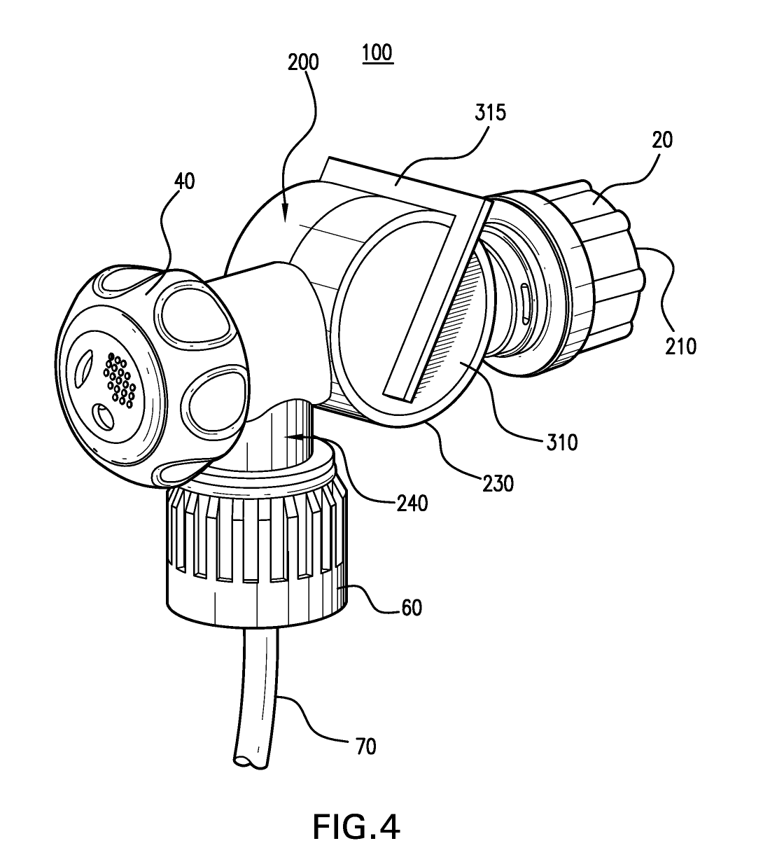

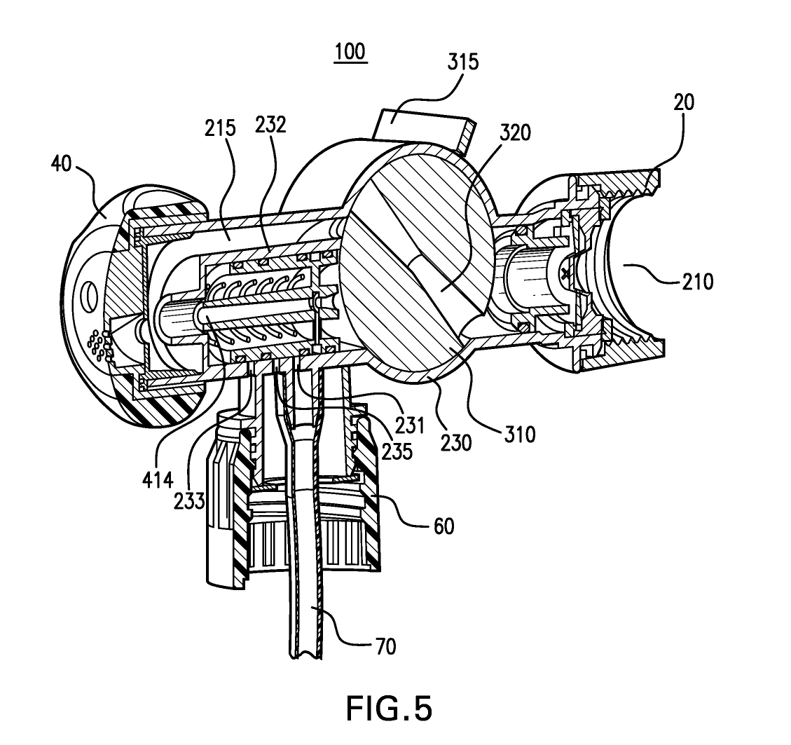

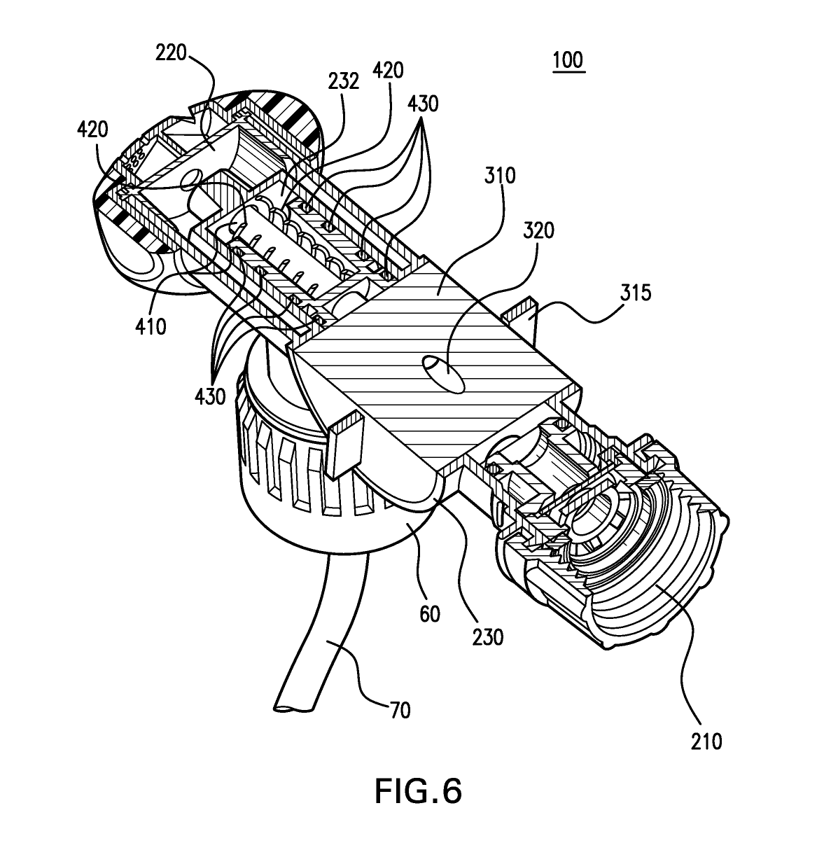

A few of the many other variations in structural embodiments formed in accordance with the present invention include, for example, the incorporation of:
1. A shuttle type check valve with a spring return (of the type illustrated in FIGS. 1-6)—but having direct feed with or without a rinse function built into the assembly.
2. A piston valve on a liquid material feed line with a control valve (digital or metering) downstream of the piston but before Venturi introduction into the pressurized fluid stream.
3. A control knob which is spring loaded on axis to be biased down against a gear or toothed/splined surface to prevent rotation, wherein fluid pressure pushes the control knob away from gear teeth/splined surface to allow free rotation.
4. A piston valve located in the throat or neck of the liquid material container such that when the sprayer is removed, the contents remain protected (contained safely within the container), its flow from the container being permitted only when a suitable sprayer is attached to the container and fluid pressure is provided to move the piston valve (to open flow access and admit atmospheric pressure into the container).
5. A piston valve located onboard a sprayer device but extending a push rod into a cavity in an actuating valve disposed at the liquid container's neck to open a port for product flow from container into the sprayer device.
6. Bellows within a sprayer device which expands when fluid pressure is provided to push a rotating, swinging, or sliding valve to open a port for product flow from the container, and which self-retracts under its own molded/formed-in spring force.
7. Bellows within a sprayer device which expands when fluid pressure is provided to push a rotating element that actuates a push rod (on the sprayer device), and which extends into the container's neck to actuate a valve to open a port for product flow from container into sprayer device.
8. Measures to use Venturi-generated vacuum to apply differential pressure to a piston valve which then opens one or more ports to the container.
9. User control means having a two-piece telescoping structure, in which the interior comprises a piston like arrangement. When water or other fluid is present and pressurized, the control knob is expanded so that surface gear teeth formed at a bottom surface engage with a corresponding rack formed on a sliding valve mechanism controlling the ports to the given container(s). A spring mechanism biases such telescoping control knob in its closed condition.

In addition to that described herein, use of hydraulic pressure to “un-lock” a valve assembly to allow dispensing may operate in several different manners depending on the particular application and type of aspiration device used within a sprayer dispenser type device. It certain embodiments, the hydraulic pressure may simply force a spring loaded pin to move, unlocking the control assembly for activation by rotating and/or sliding movement, for example. In other embodiments, the hydraulic pressure may force a spring return spool valve to slide to a position which places the container contents in communication with appropriate openings/orifices formed in the sprayer dispenser device.

For applications utilizing a Venturi style aspiration technique, the hydraulically activated interlock/seal mechanism may form a part of a back flow prevention device typically required for hose end mounted dilution systems. For units using a flow-by style of aspiration (no back flow prevention required), the interlock/seal mechanism may form a part of a carrier stream flow control assembly, such that the mechanism is operable responsive to applied hydraulic pressure, irrespective of carrier stream control assembly's condition (static or dynamic).

### Container-Integrated Embodiments

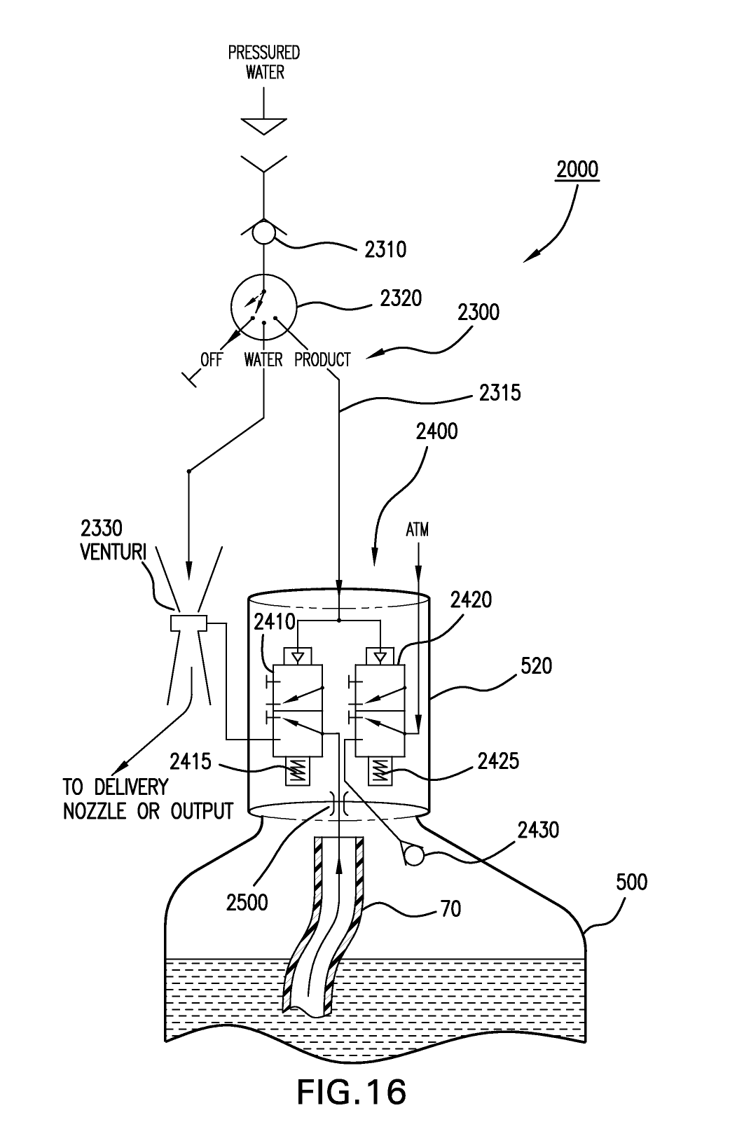

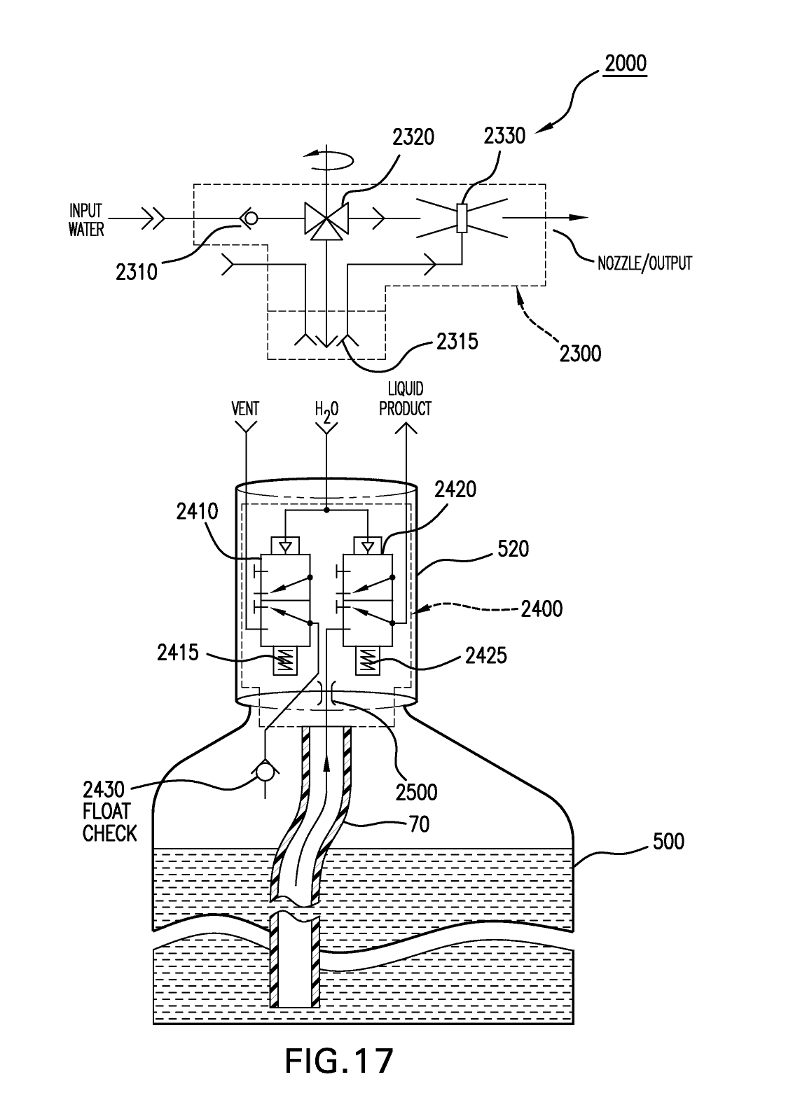

Referring now to FIGS. 16-17, there are schematically illustrated alternate embodiments of the present invention wherein a system 2000 for controlling the safe dispensing (and storage) of a given liquid material includes an operative portion which is intimately disposed within an access opening of a container 500 protectively housing the liquid material. A response valve portion 2400 which controls access to the container's contents may be captured in such embodiments substantially within the neck, or other such suitable access opening configuration formed on the container, operating to selectively seal and unseal the access opening defined thereby. As in preceding embodiments, a control valve portion 2300 serves to receive and suitably direct a pressurized stream of fluid, when necessary, to the response valve portion 2400.

Depending on the embodiment, the control valve portion 2300 may also serve much as a protective cap which shields and conceals the response valve portion 2400 within the container's opening, to guard effectively against tampering or other harmful manipulation. Alternatively, the control valve portion 2300 may be disposed apart from the container itself, though operably interconnected thereto by suitable conduit means—preferably serving in such embodiment to conduct the pressurized fluid stream to the container and the responsively released liquid material from the container back to the control valve portion 2300. Such embodiments may be preferable in those applications employing non-portable containers like wall-mounted eductors, for example.

Nonetheless, embodiments providing for the container—integrated and sealed disposition of the response valve portion 2400 yield a number of practical advantages. The control valve portion's ready detachability from the response valve portion 2400 (and from the container 500), for instance, permits its temporary removal without fear of spillage, where potential snagging or rough handling in the interim may be of concern. Detaching and separately packaging/stowing the control valve portion enables safer containment of the liquid material in those situations, leaving the container sealed by an unobtrusive, concealed response valve portion 2400. This option affords greater flexibility in packaging and/or shipping configurations, which only enhances overall safety and reliability.

As illustrated, a system 2000 formed in accordance with such exemplary embodiments generally includes a control valve portion 2300 removably coupled, preferably, to a neck portion 520 of a container 500 storing the liquid material to be dispensed. The system 2000 further includes a response valve portion 2400 preferably disposed to extend into and substantially fill and seal the bore-like access opening defined by the container's neck portion 520. The response valve portion 2400 may be secured in fluid-tight manner therein by any suitable means known in the art, such as welding, adhesive coupling, force fit frictional engagement, and the like. A suction tube 70 extends from the response valve portion 2400 into the container's storage compartment 510 to conduct the liquid material's passage therebetween.

In overall operation, the control valve portion 2300 preferably serves both as a conduit for appropriately directing an incoming pressurized stream of fluid (separately supplied from an external source), and as an effective staging/mixing vessel for properly expelling the liquid material drawn out of the container 500 along with a portion of the pressurized fluid stream. Preferably, the control valve portion 2300 is selectively configurable by the user to enable or disable the response valve portion's actuation.

When the control valve portion 2300 is configured to its enabled, or on, state (a “MIX” setting, for example), it directs at least a portion of the incoming fluid pressure to operate sufficiently upon the response valve portion 2400 and thereby effect its pressure-responsive actuation. The response valve portion 2400 preferably employs a movable member resiliently biased to either an open or closed position/configuration. Responsive to sufficient application of fluid pressure thereon, the movable member operates against the bias to move away from its default position or configuration. Preferably, this concurrently unseals both an admission port and one or more vent openings to establish an exit flow of the contained liquid material to and through an admission port 2315 for passage through the control valve portion 2300 and proper expulsion from a nozzle or other part of a delivery unit. A metering throttle 2500 of any suitable type known in the art is preferably also employed in this exit flow path to aid in regulating flow rate.

Response valve portion 2400 is schematically illustrated with valve measures 2410 and 2420 separately represented. While schematically represented in this manner for clarity of illustration, those skilled in the art will recognize that valve measures 2410 and 2420 may be realized in separate mechanisms or otherwise integrated into the same mechanism, depending on the particular requirements of the intended application.

The control valve and response valve portions 2300, 2400 may be operationally configured in much the manner described in preceding embodiments. Examples of other operational configurations which may be utilized for portions 2300, 2400 in various other embodiments include those disclosed in co-pending patent application Ser. No. 11/432,517 filed 12 May 2006. The control valve and response valve portions 2300, 2400 schematically illustrated in FIGS. 16-17 are not limited to any particular one of these operational configurations. The actual choice of such will depend on the specific requirements of the intended application.

In the schematically represented embodiment of FIGS. 16-17, the control valve portion 2300 is preferably formed to include such backflow prevention device as an anti-siphon device 2310, a flow control unit 2320, and a fluid conduit structure 2330 (preferably formed with Venturi-defining convergent and divergent portions) which ultimately feeds a nozzle or other such product expulsion portion of a dispensing head or other delivery unit. The flow control unit 2320 may be selectively configured by the user to appropriately direct all or a portion of a pressurized fluid stream received through a hose connection, or other inlet structure, and anti-siphon device 2310. Where it is configured to actuate the response valve portion 2400, the flow control unit 2320 directs at least a portion of the received pressurized fluid stream to actuate one or more valve measures 2410, 2420 for the responsive release of the liquid material product.

In the embodiment of FIG. 16, the separately illustrated valve measures 2410, 2420 illustrate the dual functions preferably served by the response valve portion 2400 in a system configuration where the liquid material product is drawn out of containment by aspiration. The first valve measure 2410 actuates responsive to the pressurized fluid stream portion acting thereon to overcome a bias provided by a resilient member 2415. This opens a flow path by which the liquid material product may flow to a suitable aspiration-inducing fluid conduit structure, such as one employing a Venturi aperture 2330, for appropriate expulsion or delivery by other means. The second valve measure 2420 similarly actuates responsive to the pressurized fluid stream to overcome the bias provided by resilient member 2425 to open a venting path by which ambient air may enter the compartment containing the liquid material product to permit its aspirated flow therefrom. Preferably, an automatically activated closure such as a float valve or check valve element 2430 is employed to seal the venting path against unwanted backflow of liquid material therethrough, in the event that the container is inverted or toppled onto its side during use while the response valve portion remains enabled.

### Sealed Collapsible Containment of Material

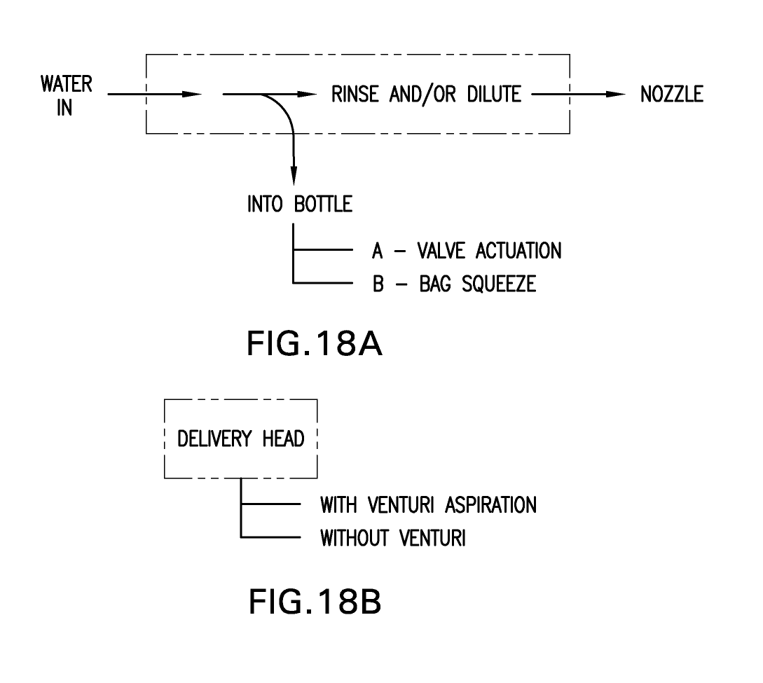

In certain embodiments, the liquid material to be dispensed may be contained in the given container's storage compartment sealed within a collapsible receptacle such as a flexible bag/pouch or the like. This is the case in the exemplary embodiments schematically indicated in FIGS. 18A-B. In such embodiments, the collapsible receptacle remains sealed except when caused by a response valve portion to open for release of the liquid material therefrom.

Use of such collapsible receptacles, particularly in the form of a flexible pouch, for liquid material storage offers numerous practical advantages. It not only provides an added measure of protection against contamination of the liquid material, for instance, it further insulates the liquid material product from unwanted escape.

Configuring the receptacle to be detachable from the other components of the system and separately disposable, moreover, adds both to the convenience and economy of use. A user may reuse the same container with many if not all of the other system components by simply replacing an empty receptacle without the potential mess and exposure hazard when the system is disassembled to get at the container's storage compartment. So long as suitable measures known in the art are carefully taken to guard against seepage during detachment/attachment of the receptacle to the given system component(s), the user may quite easily replace the spent receptacle with a pre-filled replacement, then re-assemble the system for use, appropriately discarding the spent receptacle. Providing for re-fills of the liquid material in this manner may in certain applications provide the added benefit of preserving the liquid material product's ‘freshness,’ as the material is not exposed to ambient air until it is actually dispensed.

Yet another considerable advantage in the use of a sealed collapsible receptacle for the liquid material is that it affords the liquid material's controlled release either with or without an aspirated technique, such as Venturi aspiration or the like. In the preceding embodiments, appropriate venting measures are taken to permit the entry of ambient air into the container's storage compartment such that the liquid material may be drawn by aspiration through a Venturi orifice or other such device, on to the point delivery. The sealed receptacle's collapsibility permits in the alternative a ‘squeezing’ type pressure to be externally applied thereto for the forced injection of the liquid material to the point of delivery.

As described in following paragraphs, such external pressure may be applied in certain embodiments by the same pressurized fluid stream which actuates the product release-controlling response valve portion. A further benefit derives from this in applications where the released liquid material product is to be mixed at a preferred ratio with a part of the fluid stream or other fluid prior to actual dispensing. The mixture ratio may be effectively preserved even where the pressurized fluid stream's pressure and, consequently, its flow rate at the point of delivery may fluctuate. The same fluctuation would concurrently affect the ‘squeezing’ compressive pressure applied by that pressurized fluid stream (or a portion thereof) upon the sealed receptacle, causing a corresponding fluctuation in the liquid material's expulsion pressure from the receptacle. That is, the liquid material's rate of release from the receptacle would vary in proportion to the variance of the pressure applied by the pressurized fluid stream upon the receptacle. A self-corrected dosing is effectively realized as a result.

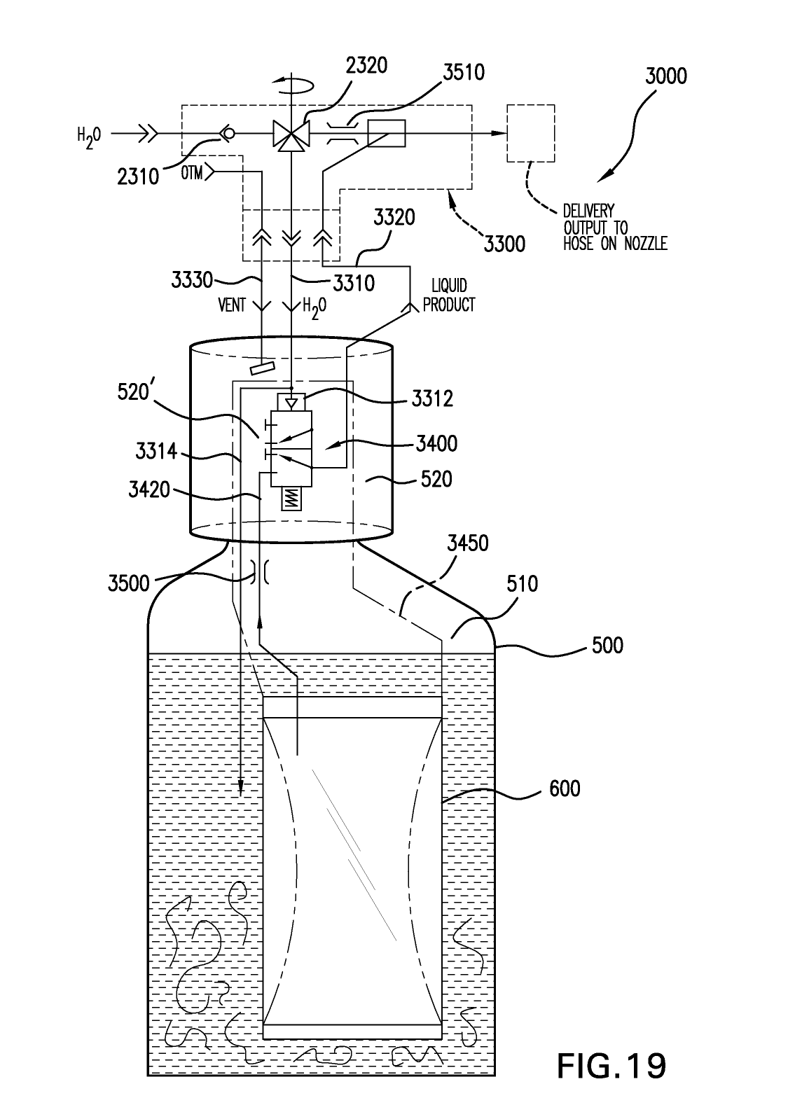

Referring now to FIG. 19, a system 3000 formed in accordance with an alternate embodiment of the present invention is schematically illustrated. System 3000 is similar in numerous respects to System 2000 illustrated in the preceding embodiment, and components/features similar to those found in preceding embodiments are symbolically illustrated in like manner and not further described in the interests of brevity and clarity. System 3000 could serve in certain applications as a retrofitted version of System 2000 wherein the liquid material otherwise stored directly in the storage compartment 510 of container 500 is alternatively contained in a sealed flexible pouch 600 or other such suitable receptacle which is collapsible for the liquid material product's controlled release therefrom.

System 3000 in this embodiment includes a control valve portion 3300 and a response valve portion 3400. Preferably, the response valve portion 3400 is secured within the access opening 520′ leading to the given container's storage compartment 510—which in the bottle-like container 500 shown is defined by a neck portion 520. The control valve portion 3300 may be detachably coupled at once to both the response valve portion 3400 and the container 500, such that fluid inlet and product outlet paths 3310, 3320 may be suitably established with the response valve portion 3400.

In this embodiment, a venting path connection 3330 otherwise provided for the storage container 510 may be left disconnected from the container 500, as the release of liquid material from the pouch 600 in this embodiment is not induced by aspiration. The liquid material's release is preferably effected by compressive means as follows. When the control valve portion 3300 is appropriately configured, at least a portion of the incoming pressurized fluid stream is directed through the fluid inlet path 3310 to the response valve portion 3400. That portion of the pressurized fluid stream directed in this manner serves via the path 3312 to actuate the response valve portion 3400 to a corresponding state, whereby a release path 3420 is opened for the exiting passage of the liquid material therethrough.

Meanwhile, the pressurized fluid stream is at least partially directed via the path 3314 into the storage compartment 510. When the storage compartment 510 fills with this fluid, the inflowing fluid stream applies and maintains a compressive force upon the pouch 600. The deflective collapse of the pouch 600 as a result serves to ‘squeeze’ the liquid material out through the release path 3420, via a metering throttle 3500, at a rate substantially proportional to the inflowing pressurized fluid stream's compressive pressure upon the pouch 600 (over an applicable range of operation). Rather than being drawn into a dispensing delivery path as in an aspirated approach, the liquid material product is in this approach effectively injected into the delivery path.

The rate at which release of the liquid material product occurs from the pouch 600 in this regard is more actively regulated in the illustrated embodiment by a metering throttle 3500 disposed in the product release path 3420. This metering throttle 3500 may employ an orifice of particular configuration, or a device of any other suitable type known in the art. In an exemplary embodiment, this metering throttle 3500 may be configured to adjustably constrict a conduit defining a portion of the product release path 3420.

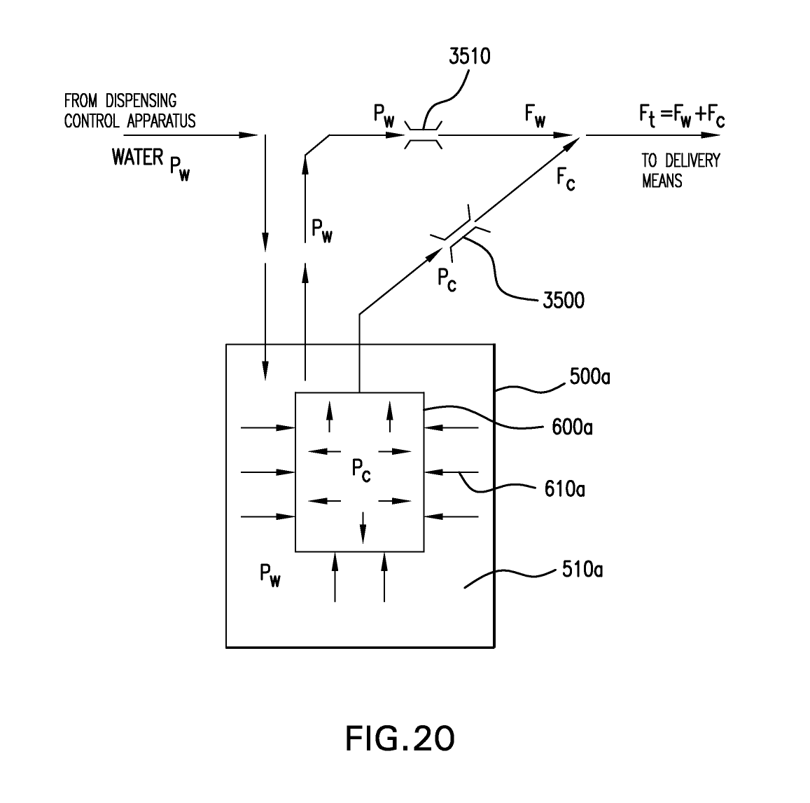

Referring to the illustrative diagram of FIG. 20, the mixing ratio for determining the concentration of liquid material product in a liquid mixture ultimately dispensed by a delivery unit may be further regulated by introducing one or more additional metering throttles 3510 of any suitable type in addition to the metering throttle 3500. For example, an additional metering throttle 3510 may be incorporated in either the control valve portion 3300 or a separate delivery unit to regulate the flow rate of the pressurized fluid stream portion that is to be mixed with the released liquid material product.

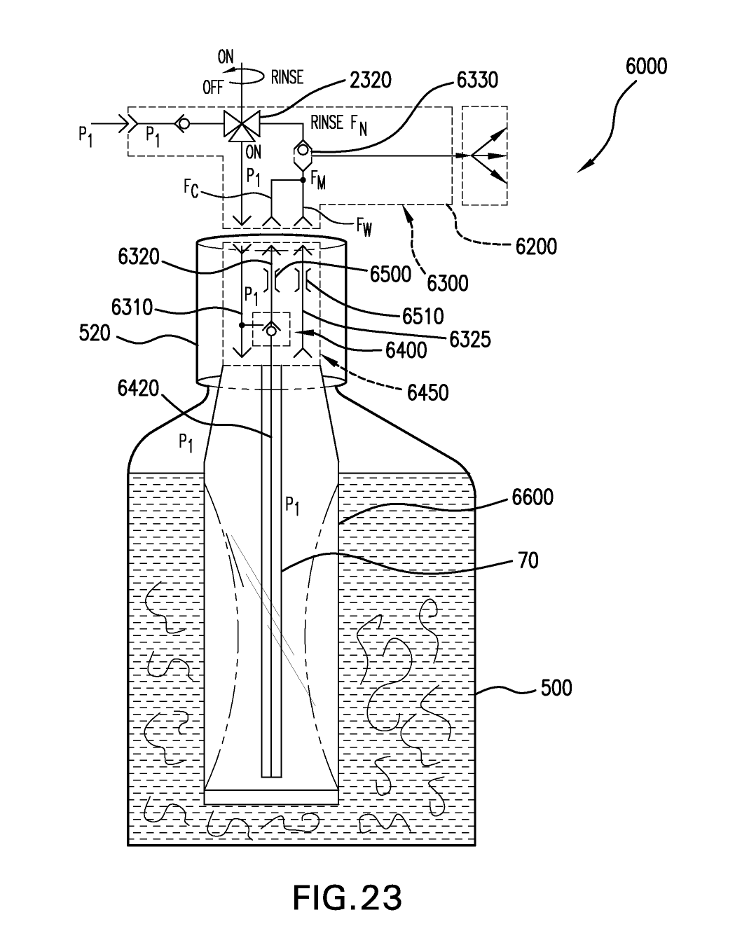

In certain embodiments, the metering throttles 3500, 3510 may alternatively be incorporated into the closure of the flexible pouch 600, as integrated parts of a flexible pouch assembly 3450 (FIG. 19). The flow of both the pressurized fluid stream and liquid product to be dispensed would then occur through a rigid container 500 and around flexible pouch 600 in one operational path. Fluidic control of mix ratio and the flow rate would effectively be integrated thereby “on-board” the flexible pouch assembly 3450, as schematically indicated. Another example of such embodiment is illustrated in FIG. 23.

In the schematic illustration of FIG. 20, the compressive pressure P_{W} generated upon the sealed flexible pouch 600a by the pressurized fluid stream directed into the container's storage compartment 510a (indicated by the arrows 610a) prompts a responsive pressure P_{C} in the liquid material product protectively contained in the pouch 600a (such as a concentrated pesticide, fertilizer, or other lawn treatment product). The liquid material product is thus ‘released’ from the pouch 600a due to the expelling pressure P_{C} to generate a flow rate F_{C} through the metering throttle 3500. When P_{W}=P_{C}, or if P_{W} is at least linearly related to P_{C}, and the pressurized fluid stream flows into the metering throttle 3510 at pressure P_{W} (or at a pressure linearly related thereto), the pressurized fluid stream's flow rate F_{W} through the metering throttle 3510 would be linearly related to F_{C}. That is, the ratio of F_{W}/F_{C} would remain constant. Any variation in the pressurized fluid stream's pressure P_{W} (and therefore its flow rate F_{W}) would yield a proportional change in the pressure P_{C}, hence in the liquid material product's flow rate F_{C}. This makes for self-corrective dosing in the liquid material product's mixed dispensing with a pressurized fluid stream, at least over certain operational ranges and within certain operational limits applicable to the intended application.

In practice, factors such as metering orifice size or relative fluid/liquid material viscosities may impose certain operational limits on the control of dosing as noted. For a particular orifice size, for example, a characteristic flow rate vs. fluid pressure curve typically approaches an operational point where the flow rate plateaus to a substantially constant value despite further increases in fluid pressure. The dosing control provided in accordance with the given embodiment of the present invention is, of course, realized at suitable operating conditions to the extent permitted by such applicable factors.

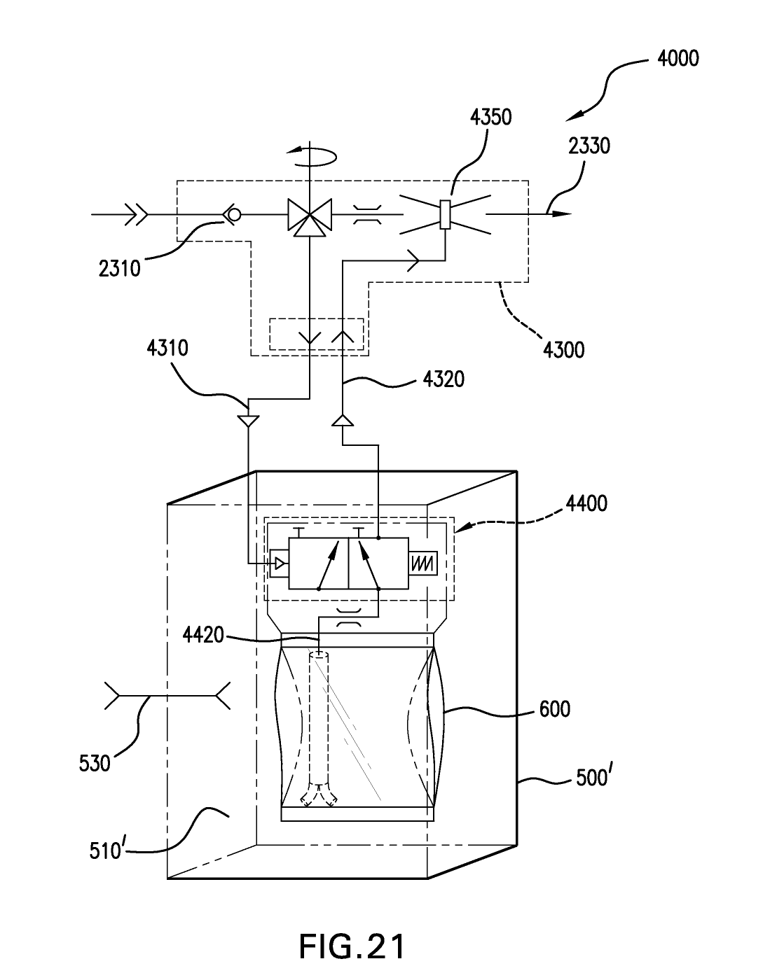

Referring back to the embodiment of FIG. 19, the container 500 is preferably formed of a rigid plastic or other such suitable material to support the generation of sufficient fluid pressure P_{W} therein. In contrast, FIG. 21 illustrates an aspirated embodiment, wherein system 4000 includes a container 500′ may be formed of paperboard or other such readily disposable material.

In this embodiment, the response valve portion 4400 is again preferably disposed in the carton-type container 500′, secured therein by threaded, snap-fit, or other suitable fastening measure known in the art. The control valve portion 4300 is detachably coupled thereto so as to establish fluid input and product release paths 4310, 4320. Because a container in the form of a paperboard carton is typically not of airtight structure, no separate venting path need be established between the control and response valve portions 4300, 4400. Rather, the venting path into the storage compartment 510′ of the carton 500′ is pre-established naturally through its unsealed seams, joints, and/or gas permeable surfaces.

No portion of the pressurized fluid stream in this embodiment is actually introduced into the container's storage compartment 510′. At least a portion of the pressurized fluid stream is passed preferably through a sealed fluid link 4310 just for the purpose of actuating the response valve portion 4400, where it overcomes the resilient bias of response valve portion and sets the same to the appropriate controlling state.

As before, a collapsible receptacle is provided in the form of a flexible pouch 600—sealed except at its link 4420 to the response valve portion 4400. The flexible pouch 600 safely stores the liquid material product in sealed manner until release. A feed tube 70 is preferably disposed within the flexible pouch 600 to extend from the product release link 4420 to the pouch bottom. The feed tube 70 is so configured and arranged that it maintains an effective feed path for the liquid material despite the flexible pouch's collapse, which might otherwise seal off the liquid material in certain portions. Internal ribbing or other suitable internal support measures may be incorporated with or in place of the feed tube 70 to guard against such seal-off, or even to reinforce the feed tube itself against sealing constriction as the pouch 600 collapses around it.

The control valve portion 4300 of system 4000 is preferably of the type employed in preceding embodiments wherein a fluid conduit structure 4350, incorporating the converging and diverging areas sufficient for Venturi operation, is provided with a Venturi aperture communicating with a product feed path 4320 leading from the response valve portion 4400. When the response valve portion 4400 is actuated during operation by a sufficiently pressurized fluid stream via the fluid path 4310, it suitably establishes communication between the feed path 4320 and the product release path 4420 therethrough. Sufficient inflow of ambient air into the storage compartment 510′ occurring through the various venting paths existing through the container 500′ itself enables the liquid product to be drawn into the fluid conduit 4350 by aspiration through the Venturi aperture. The otherwise sealed flexible pouch 600 is free due to the venting of its surrounding storage compartment 510′ to collapse responsive to the withdrawal of liquid material therefrom until it is fully evacuated.

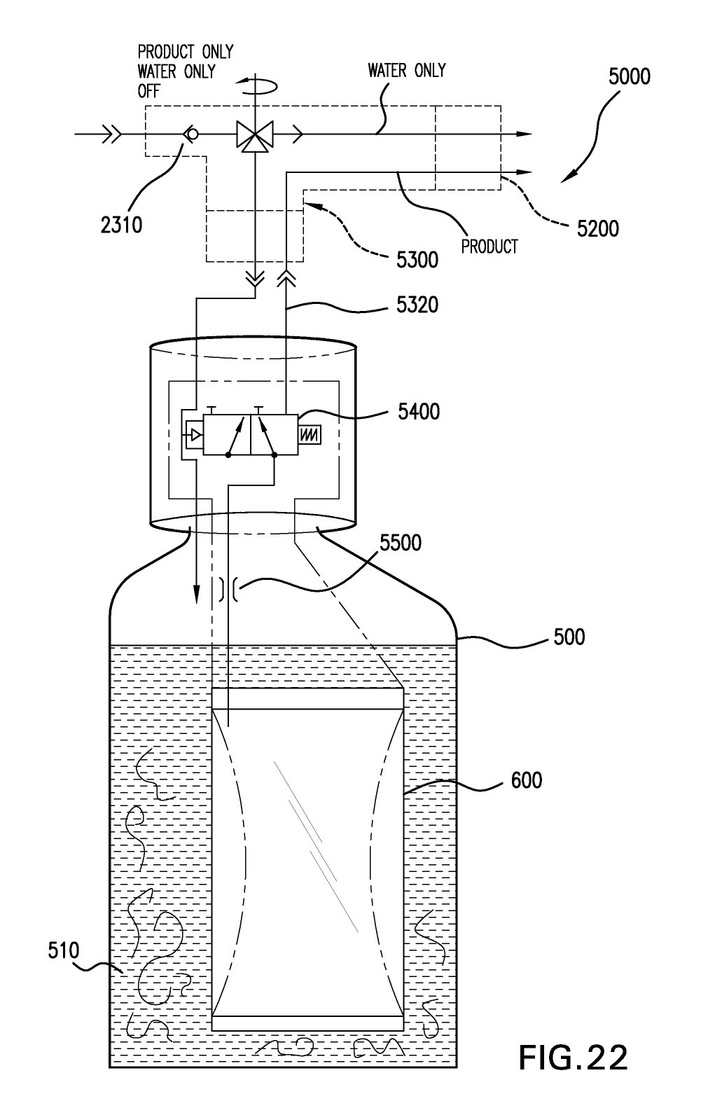

Referring next to FIG. 22, there is schematically illustrated an exemplary system 5000 formed in accordance with yet another alternate embodiment of the present invention. As in system 3000 illustrated in the embodiment of FIG. 19, system 5000 employs a collapsible receptacle 600 housed within the storage compartment 510 of a rigid bottle or other container 500 formed of a liquid impermeable material. The control valve and response valve portions 5300, 5400 operate much as in system 3000 to control non-aspirated release of the liquid material from the flexible pouch 600. At least a portion of the incoming pressurized fluid stream is directed into the storage compartment 510 to apply external compressive pressure in this regard upon the flexible pouch 600.

Unlike system 3000, however, the released liquid material is passed through a metering throttle 5500, the response valve portion 5400, and the product feed path 5320 on to the delivery unit 5200 for direct, undiluted expulsion therefrom. The liquid material is not mixed as in system 3000 with any portion of the pressurized fluid stream, for it is provided in the flexible pouch 600 in ready-to-dispense form.

Turning to FIG. 23, there is illustrated an exemplary system 6000 formed in accordance with another embodiment of the present invention. In this embodiment, system 6000 employs a response valve portion 6400 that is disposed with a pouch 6600, within an integrated pouch assembly 6450. The response valve portion-containing part of the integrated pouch assembly 6450 is preferably configured such that it may be detachably fastened to or within a suitable portion of the given container 500, such as its neck portion 520. Respectively threaded surfaces or other suitable means known in the art may be provided for the respective engaging parts of the integrated pouch assembly 6450 and the container's neck portion 520. Where the container is itself intended to be disposable, the integrated pouch assembly 6450 may alternatively be more permanently fastened to the container 500 by welding or other suitable means. Regardless, the pouch 6600 and response valve portion 6400 are provided in this embodiment together as integrated parts of the pouch assembly 6450, such that they may be conveniently and safely used, replaced, or disposed of together, as a unit.

The integrated pouch assembly 6450 is preferably configured to define each of a fluid path 6310 for receiving a pressurized fluid stream directed thereto, a feed path 6320 for dispensing passage of the given liquid material product, and a fluid return path 6325 for the outflow passage of the pressurized fluid stream therefrom. As in certain of the preceding embodiments, the pressurized fluid stream (or portion thereof) received by the integrated pouch assembly 6450, through the fluid path 6310, enters the container 500. Once the fluid sufficiently fills the storage compartment, its continued inflow applies a squeezing pressure upon the pouch 6600. Ongoing inflow of the pressurized fluid stream into the container's storage compartment maintains the squeezing pressure, while the response valve portion 6400 is concurrently actuated responsive to the inflowing fluid stream to open the way for the liquid material product's consequent ejection through the release path 6420, on to the feed path 6320.

As the storage compartment of the preferably rigid container 500 is limited in volume, the pressurized fluid introduced into the storage compartment circulates out through the return path 6325 during continued operation. Both the fluid path 6310 and fluid return path 6325 accordingly remain in open communication with that part of the container's storage compartment outside the pouch 6600.

Preferably, metering throttles 6500, 6510 are respectively provided in the feed path 6320 and fluid return path 6325 to provide a measure of flow rate regulation and control in each. The metering throttles 6500, 6510 may include an orifice of suitable configuration, or otherwise include other suitable elements known in the art. The metering throttles 6500, 6510 are also preferably provided as part of the integrated pouch assembly 6450, as shown.

The system 6000 further includes in this embodiment a control valve portion 6300 which, when operably coupled to the integrated pouch assembly 6450, provides selectively for the mixed dispensing of the liquid material product and pressurized fluid stream, with both being provided from the container (and integrated pouch assembly 6450). Control valve portion 6300, preferably disposed as part of a delivery unit 6200, includes toward these ends a flow control unit 2320 which enables a user's selection of ON, OFF, or RINSE modes of operation. The control valve portion 6300 provides suitable conduit measures for operable coupling to communicate with each of the fluid, product feed, and fluid return paths 6310, 6320, 6325 of the integrated pouch assembly 6450.

During operation, the flow of pressurized fluid stream is blocked by the flow control unit 2320 when in its OFF setting. When in its RINSE setting, the flow control unit 2320 directs the incoming stream of pressurized fluid directly to a check valve 6330 at the given rinsing flow rate F_{W} for unmitigated expulsion by the delivery unit 6200. When in its ON setting, the flow control unit 2320 directs the incoming stream of pressurized fluid to the coupled fluid path 6310 of the integrated pouch assembly 6450, whereupon the released liquid material product and returning fluid stream (provided through the respective feed and fluid return paths 6320, 6325 of the integrated pouch assembly 6450) are appropriately mixed and conducted at a mixture flow rate F_{M} to the check valve 6330 for expulsion through the delivery unit 6200.

The check valve 6330 is preferably of a differential pressure shuttle type, though it may be of any other suitable type known in the art. The check valve 6330 operates to guard against unintended flow of the given stream. That is, check valve 6330 opens to conduct the outward flow of either the fluid rinse stream or liquid product/fluid mixture stream provided thereto, while effectively blocking the potential flow of each stream to the other's source.

As in preceding embodiments, the feed tube 70 disposed within the integrated pouch assembly 6450 of this embodiment is preferably of sufficient rigidity to prevent any part of the pouch 6600 from being prematurely cut off during pouch's collapse. The feed tube 70 is preferably formed to extend substantially the length of the pouch 6600, with perforations formed therealong to facilitate efficient drainage of liquid material therethrough during product release.

While the integrated pouch assembly 6450 is shown with but a single pouch 6600, it may in certain variations of the given embodiment include a plurality of such flexible pouches 6600. In those cases, respective metering throttles 6510 may be separately provided for the respective feed paths 6320 associated with the pouches 6600.

In other variations of system 6000, the internal compartment of the container 500 may be configured to permit the escape of air, while sealing against the flow of pressurized fluid through the air escape path. A float valve or other such device known in the art, for example, may be suitably employed for that purpose. These variations may be particularly suitable in applications where the liquid material is provided by the pouch 6600 in ready-to-dispense form (without diluting mixture). Examples may include applications with such liquid materials as paints, stains, solvent-based chemicals, and the like—wherein the liquid material is either water insoluble or not conducive to combined delivery with water.

Although this invention has been described in connection with specific forms and embodiments thereof, it will be appreciated that various modifications other than those discussed above may be resorted to without departing from the spirit or scope of the invention. For example, equivalent elements may be substituted for those specifically shown and described, certain features may be used independently of other features, and in certain cases, particular combinations of method steps may be reversed or interposed, all without departing from the spirit or scope of the invention as defined in the appended claims.

What is claimed is:

1. A system for failsafe storage and adaptively dosed dispensing of a liquid material with a pressurized fluid stream directed thereto, the system comprising:
at least one collapsible receptacle for use within a storage compartment, said collapsible receptacle storing the liquid material in sealed manner therein;
a dispensing control unit operably coupled to said collapsible receptacle, said dispensing control unit including a response valve portion coupled to said collapsible receptacle, said response valve portion being reconfigurable responsive to at least a portion of the pressurized fluid stream upon the pressurized fluid stream being directed through said storage compartment, said response valve portion being reconfigured thereby to control release of the liquid material from said collapsible receptacle through a release path into the pressurized fluid stream for mixture therewith, said response valve portion being disposed in the release path of the liquid material;
said response valve portion in a first state sealing said collapsible receptacle, and in a second state being in open communication with said collapsible receptacle;
said response valve portion being biased to said first state, whereby release of the liquid material therethrough is prevented in the absence of suitable fluid pressure actuation therefor; and,
a first metering throttle disposed in said release path and a second metering throttle disposed in a path of the pressurized fluid path, said first and second metering throttles being dimensionally configured respectively to define a preselected mixture ratio between said liquid material and the pressurized fluid stream, said preselected mixture ratio being maintained in a manner independent of the pressurized fluid stream pressure.

2. The system as recited in claim 1, wherein at least a portion of a pressurized fluid stream is directed by the dispensing control unit into said storage compartment for generating a fluid pressure upon said collapsible receptacle, whereby the release of liquid material from said collapsible receptacle in a mixture with the pressurized fluid stream is adaptively maintained at a consistent dose independent of the applied fluid pressure.

3. The system as recited in claim 2, wherein said container includes a body formed of a substantially rigid and liquid impermeable material substantially defining said storage compartment.

4. The system as recited in claim 3, wherein at least one of said first and second metering throttles is adjustable.

5. The system as recited in claim 1, wherein said dispensing control unit includes a control valve portion operably coupled to said response valve portion to selectively direct at least a portion of the pressurized fluid stream thereto.

6. The system as recited in claim 11, wherein said first and second metering throttles are disposably integrated with said dispensing control unit and in a pouch assembly.

7. A system for failsafe storage and dispensing of a liquid material comprising:
a container defining a storage compartment and an access opening in communication therewith;
at least one flexible pouch disposed within said storage compartment for sealed storage of the liquid material therein;
a delivery unit for expelling the liquid material released from the flexible pouch;
a dispensing control unit coupled to said container and said delivery unit, said dispensing control unit including:
a control valve portion operable to selectively direct a flow path of at least a portion of a pressurized fluid stream received thereby; and,
a response valve portion engaging said access opening of said container and coupled to said flexible pouch, said response valve portion being reconfigurable responsive to at least a portion of the pressurized fluid stream upon the pressurized fluid stream being directed through said storage compartment, said response valve portion being reconfigured thereby to control release of the liquid material from said collapsible receptacle through a release path into the pressurized fluid stream for mixture therewith, said response valve portion being disposed in the release path of the liquid material, said response valve portion in a first state sealing said flexible pouch, and in a second state being in open communication with said flexible pouch;
said response valve portion being resiliently biased to said first state, whereby release of the liquid material therethrough is prevented in the absence of suitable fluid pressure actuation therefor; and,
a first metering throttle disposed in said release path and a second metering throttle disposed in a path of the pressurized fluid path for respectively regulating the pressure driven rates of passage therethrough, said first and second metering throttles being dimensionally configured respectively to define a preselected mixture ratio between said liquid material and the pressurized fluid stream, said preselected mixture ratio being maintained in a manner independent of the pressurized fluid stream pressure.

8. The system as recited in claim 7, wherein at least a portion of a pressurized fluid stream is directed by said dispensing control unit into said storage compartment for applying a fluid pressure upon said flexible pouch, whereby the release of liquid material from said collapsible receptacle in a mixture with the pressurized fluid stream is adaptively maintained at a consistent dose independent of the applied fluid pressure.

9. The system as recited in claim 8, wherein said container includes a carton having an air-pervious construction defining said storage compartment.

10. The system as recited in claim 9, wherein at least one of said first and second metering throttles is adjustable.

11. The system as recited in claim 10, wherein said delivery unit includes a mixing chamber receiving at least a portion of the pressurized fluid stream and the liquid material released from said flexible pouch for the combined expulsion thereof.

12. The system as recited in claim 11, wherein said first and second metering throttles are disposed in said dispensing control unit for regulated passage of the released liquid material and pressurized fluid stream portion respectively therethrough into said delivery unit.

13. The system as recited in claim 12, wherein said first and second metering throttles are disposably integrated within a pouch assembly including said delivery unit and said flexible pouch.

14. A system for failsafe storage and adaptively dosed dispensing of a liquid material with a pressurized fluid stream directed thereto, the system comprising:
a pouch assembly including at least one collapsible receptacle for use within a storage compartment, said collapsible receptacle storing the liquid material in sealed manner therein;
a dispensing control unit integrated in said pouch assembly, said dispensing control unit including:
a response valve portion coupled to said collapsible receptacle, said response valve portion being reconfigurable responsive to at least a portion of the pressurized fluid stream upon the pressurized fluid stream being directed through said storage compartment, said response valve portion being reconfigured thereby to control release of the liquid material from said collapsible receptacle through a release path into the pressurized fluid stream for mixture therewith, said response valve portion being disposed in the release path of the liquid material;
said response valve portion in a first state sealing said collapsible receptacle, and in a second state being in open communication with said collapsible receptacle;
said response valve portion being biased to said first state, whereby release of the liquid material therethrough is prevented in the absence of suitable fluid pressure actuation therefor; and,
at least first and second metering throttles integrated in said pouch assembly, said first metering throttle disposed in said release path and said second metering throttle disposed in a path of the pressurized fluid path, said first and second metering throttles being dimensionally configured respectively to define a preselected mixture ratio between said liquid material and the pressurized fluid stream, said preselected mixture ratio being maintained in a manner independent of the pressurized fluid stream's pressure.

15. The system as recited in claim 14, wherein at least a portion of a pressurized fluid stream is directed by the dispensing control unit into said storage compartment for generating a fluid pressure upon said collapsible receptacle, whereby the release of liquid material from said collapsible receptacle in a mixture with the pressurized fluid stream is adaptively maintained at a consistent dose independent of the applied fluid pressure.

16. The system as recited in claim 15, wherein said container includes a body formed of a substantially rigid and liquid impermeable material substantially defining said storage compartment.

17. The system as recited in claim 16, wherein at least one of said first and second metering throttles is adjustable.

18. The system as recited in claim 17, wherein said dispensing control unit includes a control valve portion operably coupled to said response valve portion to selectively direct at least a portion of the pressurized fluid stream thereto.
